(19) United States
(12) Patent Application Publication
(10) Pub. No.: US 2025/0317895 A1
(43) Pub. Date: Oct. 9, 2025

(54) Determining UE Orientation to Support Next Generation Application

(71) Applicant: Telefonaktiebolaget LM Ericsson (publ), Stockholm (SE)

(72) Inventors: Jianxin Qu, Linköping (SE); Nikil Johny Kunnappallil, Mölndal (SE); Yuxin Zhao, Linköping (SE); Deep Shrestha, Linköping (SE)

(21) Appl. No.: 18/865,048

(22) PCT Filed: May 17, 2023
(86) PCT No.: PCT/SE2023/050487

§ 371 Date: Nov. 12, 2024

Related U.S. Application Data
(60) Provisional application No. 63/364,954, filed on May 19, 2022.

(51) Int. Cl. H04W 64/00; H04L 5/00; H04W 8/22; H04W 24/10

(52) U.S. Cl. CPC H04W 64/006; H04L 5/0051; H04W 8/22; H04W 24/10

(57) ABSTRACT

The present disclosure relates to a method performed by a UE (105) for handling information of relevance during a positioning occasion in a communications system (100). The UE (105) obtains assistance information from a network node (101). The UE (105) measures reference signals based on the assistance information. The UE (105) provides positioning measurement information based on the measured reference signals to the network node (101). The UE (105) obtains UE orientation information from the network node (101). The UE orientation information has been estimated by the network node (101). The UE (105) obtains information of relevance from the network node (101). The information of relevance is dependent on a UE position in which the UE (105) is currently located and a UE orientation. The UE (105) takes an action based on the obtained information of relevance.

### TECHNICAL FIELD

The present disclosure relates generally to a User Equipment (UE), a method performed by the UE, a network node and a method performed by the network node. More particularly, the present disclosure relates to handling information of relevance in a communications system. The present disclosure relates to enable estimation of orientation of a UE, e.g. a mobile communication device. The present disclosure caters on the positioning measurements that otherwise were exploited only to localize UE.

### BACKGROUND

### Positioning in NR

Positioning has been a topic in Long Term Evolution (LTE) standardization since the Third Generation Partnership Project (3GPP) Release 9. The primary objective of positioning in LTE was to fulfill regulatory requirements for emergency call localization where the target was to achieve <50 m horizontal accuracy.

Starting from Release 15 specification, positioning is also supported in New Radio (NR). Positioning in NR is supported by the architecture shown in FIG. 1. FIG. 1 illustrates a Next Generation-Radio Access Network (NG-RAN) comprising two network nodes 101 represented by a Next Generation Node B (gNB) and a Next Generation-Evolved Node B (ng-eNB) in FIG. 1. The gNB 101 is exemplified in FIG. 1 to comprise two Transmission and Reception Points (TRP). The ng-eNB 101 is exemplified in FIG. 1 to comprise two Transmission Points (TP). Both the gNB 101 and the ng-eNB 101 are arranged to be connected to each other via an Xn interface. The ng-eNB is arranged to be connected to a UE 105 via a LTe-Uu interface and the gNB 101 is arranged to be connected to the same UE 105 via a NR-Uu interface. The UE 101 comprises a Secure User Plane Location (SUPL) Enabled Terminal (SET). The ng-eNB 101 is arranged to be connected to an Access and Mobility Management Function (AMF) via a Next Generation-Control (NG-C) interface. The gNB 101 is arranged to be connected to the same AMF via another NG-C interface. The AMF is arranged to be connected to a Location and Mobility Function (LMF) 110 via a NLs interface.

The interactions in FIG. 1 between the gNB 101 and the UE 105 are supported via the Radio Resource Control (RRC) protocol, while the location node, i.e. the LMF 110, interfaces with the UE 105 via the LTE positioning protocol (LPP). LPP is a common protocol to both NR and LTE. LMF 110 is the location node in NR. There are also interactions between the location node 110 and the gNB 101 via the NR Positioning Protocol annex (NRPPa) protocol.

In comparison to LTE, NR positioning benefits from larger bandwidth and finer beamforming and can localize a UE 105 with higher accuracy and supports the following positioning methods:
Downlink Time Difference of Arrival (DL-TDoA)
Uplink Relative Time of Arrival (UL-RToA)
Downlink Angle of Departure (DL-AoD)
Uplink Angle of Arrival (UL-AoA), including Azimuth of arrival and Zenith of arrival
Multi-Round Trip Time (RTT) positioning
NR Enhanced Cell ID.

Among these positioning methods, DL-TDoA, UL-RToA, and Multi-RTT make use of the timing measurements to localize a UE 105. A timing measurement used for UE positioning can be unidirectional or it can be bidirectional. Unidirectional timing measurement is used by a first node (Node1) for measuring transmit timing of signal transmitted by Node1 or for measuring reception timing of signal received by Node1 from a second node (Node2). Bidirectional timing measurement is used by Node1 for measuring relation between the transmit timing of signal transmitted by Node1 and the reception timing of signal received at Node1 from Node2. An example of the relation is the difference between the transmission and the reception timings. In the timing measurements in one example, Node1 may measure the absolute reception timing of the signal and/or it may measure reception timing of the signal with respect to a reference time. Similarly in one example, Node1 may measure the absolute transmit timing of the signal and/or it may measure transmit timing of the signal with respect to a reference time. An example of bidirectional timing measurement is round trip time (RTT). Examples of unidirectional timing measurements are Reference Signal Time Difference (RSTD) performed by the UE, Uplink Relative Time of Arrival (UL RTOA) performed by the base station etc. In NR, following are the measurements that are performed by the UE 105 during a positioning occasion:
1. RSTD: It is reference signal time difference between the positioning node j and the reference positioning node i. It is measured on the Downlink Positioning Reference Signal (DL PRS) signals and always involves two cells. A cell may be interchangeably called TRP.
2. UE Rx-Tx time difference: It is defined as T_{UE-RX}−T_{UE-TX}
   Where:
      T_{UE}-RX is the UE received timing of downlink subframe #i from a positioning node, defined by the first detected path in time. It is measured on Positioning Reference Signal (PRS) signals received from the gNB 101.
      T_{UE}-TX is the UE transmit timing of uplink subframe #j that is closest in time to the subframe #i received from the positioning node. It is measured on Sounding Reference Signals (SRS) transmitted by the UE 105.

And following are measurements that are performed by gNB 101 during a positioning occasion:
1. gNB Rx-Tx time difference: It is defined as T_{gNB-RX}−T_{gNB-TX}
   Where:
      T_{gNB-RX} is the positioning node received timing of uplink subframe #i containing SRS associated with UE 105, defined by the first detected path in time. It is measured on SRS signals received from the UE 105.
      T_{gNB-TX} is the positioning node transmit timing of downlink subframe #j that is closest in time to the subframe #i received from the UE 105. It is measured on PRS signals transmitted by gNB 101.
2. Timing advance (T_{A}DV): It is defined as the time difference T_{ADV}=(T_{gNB-RX}−T_{gNB-TX}),
   Where:
      T_{gNB-RX} is the Transmission and Reception Point (TRP) received timing of uplink subframe #i containing Physical Random Access Channel (PRACH) transmitted from UE 105, defined by the first detected path in time.
      T_{gNB-TX} is the TRP transmit timing of downlink subframe #j that is closest in time to the subframe #i received from the UE 105.
      The detected PRACH is used to determine the start of one subframe containing that PRACH.
3. UL Relative Time of Arrival (UL RTOA): It is defined as the beginning of subframe i containing SRS received in positioning node j, relative to the configurable reference time. For example, node1 (e.g. base station etc.) measures the reception time of signals transmitted by the UE 105 with respect to a reference time.

Apart from the timing measurements, DL-AoD and UL-AoA methods make use of the angular measurements to localize UE 105. DL-AoD is a DL measurement performed and reported by UE 105. UL AoA is a UL measurement performed and reported by the gNB 101. Angular measurements may also be combined with timing measurements for UE localization.

The existing cellular network-based solution is limited to UE localization. To support next generation use cases such as augmented reality, virtual reality, remote navigation, sensing etc. location information of UE 105 alone is not enough. Estimation of UE orientation such that relevant information for navigation, augmentation can be fed to UE 105 or significance of sensing information can be enriched provided that the orientation of the UE 105 is known when the sensing measurements (in both bistatic and multistatic setting) were done.

Therefore, there is a need to at least mitigate or solve this issue.

### SUMMARY

An object is to obviate at least one of the above disadvantages and to provide improved handling of assistance information in the communications system. The object may be described to enable estimation of orientation of a UE, e.g. a mobile communication device. The object may be described to cater on the positioning measurements that otherwise were exploited only to localize UE.

According to a first aspect, the object is achieved by a method performed by a UE for handling information of relevance during a positioning occasion in a communications system. The UE obtains assistance information from a network node. The assistance information is related to reference signals measurable by the UE. The UE measures reference signals based on the assistance information. The reference signals are measured from reference TRP and target TRPs. The UE provides positioning measurement information based on the measured reference signals to the network node. The UE obtains UE orientation information from the network node. The UE orientation information has been estimated by the network node. The UE obtains information of relevance from the network node. The information of relevance is dependent on a UE position in which the UE is currently located and UE orientation in which the UE 105 is currently orientated. The UE takes an action based on the obtained information of relevance.

According to a second aspect, the object is achieved by a method performed by a network node for handling information of relevance during a positioning occasion in a communications system. The network node provides assistance information to the UE. The assistance information is related to positioning and/or information about a reference signal measurable by the UE. The network node obtains positioning measurement information from the UE. The positioning measurement information is based on reference signals from reference TRPs and target TRPs. The network node determines UE orientation based on the positioning measurement information, and provides information of relevance to the UE. The information of relevance is dependent on UE position in which the UE is currently located and the UE orientation in which the UE 105 is currently orientated.

According to a third aspect, the object is achieved by UE for handling information of relevance during a positioning occasion in a communications system. The UE is adapted to perform the method of the first aspect.

According to a fourth aspect, the object is achieved by network node for handling information of relevance during a positioning occasion in a communications system. The network node is adapted to perform the method of the second aspect Thanks to the positioning measurements, that otherwise are exploited to only localize the UE, it is possible to estimate the UE orientation. Estimation of UE orientation such that relevant information for navigation, augmentation may be fed to UE or significance of sensing information can be enriched provided that the orientation of the UE is known when the sensing measurements.

The present disclosure herein affords many advantages, of which a non-exhaustive list of examples follows:

The UE position and orientation is known to the network. Based on one of the proposed methods, the present disclosure provides an advantage of that the network node does not have to rely on availability of sensor at UE for orientation measurement.

Another advantage of the present disclosure may be that the network node can make use of orientation information and location information to provide information of relevance depending on the location and orientation of the UE.

A further advantage of the present disclosure may be that the information of relevance could be navigation instruction based on which UE may change its position to new position and gets remotely navigated to its destination.

A further advantage of the present disclosure may be that the information of relevance could be augmented data based on the UE orientation and its location.

A further advantage of the present disclosure may be that the information of relevance could be the estimated location and orientation of the UE that UE may further exploit to take further actions.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a schematic drawing illustrating a positioning architecture in NR.

FIG. 2 is a schematic drawing illustrating a communications system.

FIG. 3 is a schematic drawing illustrating UE and its orientation.

FIG. 4 is a schematic drawing illustrating deployment of a UE.

FIG. 5 is a graph illustrating UE orientation estimation.

FIG. 6 is a signaling diagram illustrating a method.

FIG. 7 is a signaling diagram illustrating a method.

FIG. 8 is a signaling diagram illustrating a method.

FIG. 9 is a signaling diagram illustrating a method.

FIG. 10 is a flow chart illustrating a method performed by a UE.

FIG. 11 is a flow chart illustrating a method performed by a network node.

FIG. 12 is a flow chart illustrating a method performed by a UE.

FIG. 13 is a flow chart illustrating a method performed by a network node.

FIG. 14 is a schematic drawing illustrating an architecture for separation of gNB Central Unit Control Plane (gNB-CU-CP) and gNB Central Unit User Plane (gNB-CU-UP).

FIG. 15 is a flow chart illustrating a method performed by a UE.

FIG. 16 is a flow chart illustrating a method performed by a network node.

FIG. 17a is a schematic drawing illustrating a UE.

FIG. 17b is a schematic drawing illustrating a UE.

FIG. 18a is a schematic drawing illustrating a network node.

FIG. 18b is a schematic drawing illustrating a network node.

FIG. 19 is a schematic block diagram illustrating a telecommunication network connected via an intermediate network to a host computer.

FIG. 20 is a schematic block diagram of a host computer communicating via a base station with a UE over a partially wireless connection.

FIG. 21 is a flowchart depicting a method in a communications system comprising a host computer, a base station and a UE.

FIG. 22 is a flowchart depicting a method in a communications system comprising a host computer, a base station and a UE.

FIG. 23 is a flowchart depicting a method in a communications system comprising a host computer, a base station and a UE.

FIG. 24 is a flowchart depicting a method in a communications system comprising a host computer, a base station and a UE.

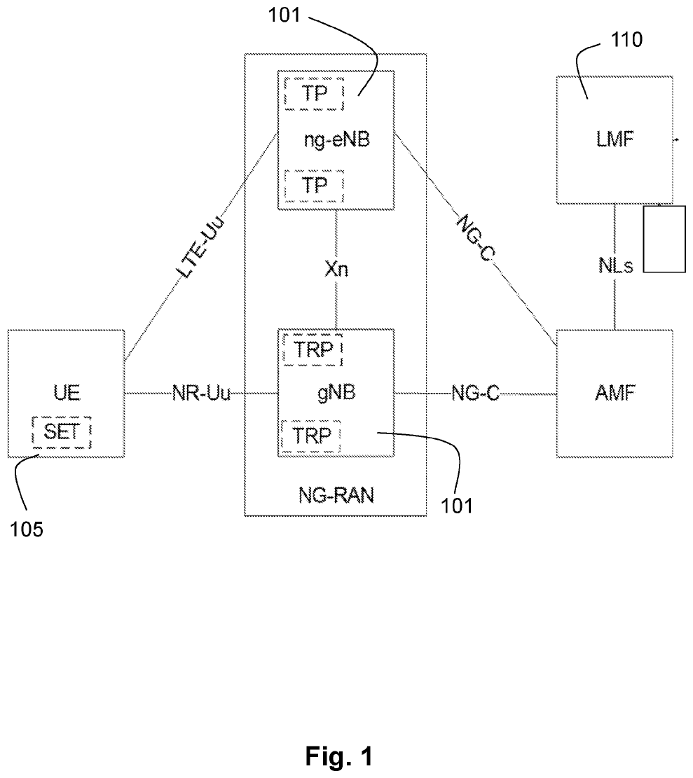

The drawings are not necessarily to scale, and the dimensions of certain features may have been exaggerated for the sake of clarity. Emphasis is instead placed upon illustrating the principle.

### DETAILED DESCRIPTION

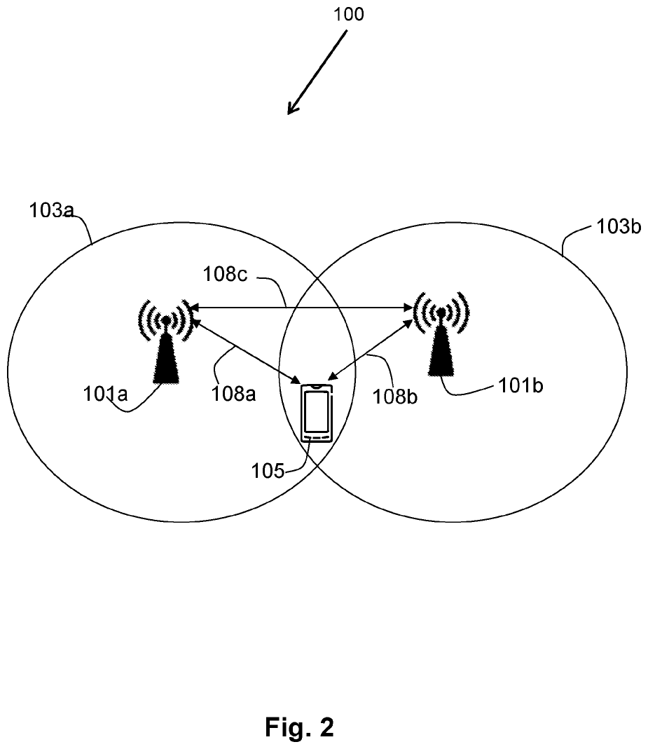

FIG. 2 depicts a non-limiting example of a communications system 100, which may be a wireless communications system, sometimes also referred to as a wireless communications network, cellular radio system, or cellular network, in which the present disclosure may be implemented. The communications system 100 may be a Fifth Generation (5G) system, 5G network, New Radio-Unlicensed (NR-U) or Next Gen system or network. The communications system 100 may alternatively be a younger system or older system than a 5G system, such as e.g. a Second Generation (2G) system, a Third Generation (3G) system, a Fourth Generation (4G) system, a Sixth Generation (6G) system, a Seventh Generation (7G) system etc. The communications system 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, Narrowband-Internet of Things (NB-IoT). Thus, although terminology from 5G/NR and LTE may be used in this disclosure to exemplify, this should not be seen as limiting to only the aforementioned systems.

The communications system 100 comprises one or a plurality of network nodes, whereof a first network node 101a and a second network node 101b are depicted in the non-limiting example of FIG. 2. Any of the first network node 101a, and the second network node 101b may be a radio network node, such as a radio base station, or any other network node with similar features capable of serving a user equipment, such as a wireless device or a machine type communication device, in the communications system 100. The first network node 101a may be an eNB and the second network node 101b may be a gNB. The first network node 101a may be a first eNB, and the second network node 101b may be a second eNB. The first network node 101a may be a first gNB, and the second network node 101b may be a second gNB. The first network node 101a may be a MeNB and the second network node 101b may be a gNB. Any of the first network node 101a and the second network node 101b may be co-localized, or they may be part of the same network node. The first network node 101a may be referred to as a source node or source network node, whereas the second network node 101b may be referred to as a target node or target network node. When the reference number 101 is used herein without the letters a or b, it refers to a network node in general, i.e. it refers to any of the first network node 101a or second network node 101b.

The communications system 100 covers a geographical area which may be divided into cell areas, wherein each cell area may be served by a network node, although, one network node may serve one or several cells. In FIG. 2, the communications system 100 comprises a first cell 103a and a second cell 103b. Note that two cells are exemplified in FIG. 2 only as an example, and that any n number of cells may be comprised in the communication system 100, where n is any positive integer. A cell is a geographical area where radio coverage is provided by the network node at a network node site. Each cell is identified by an identity within the local network node area, which is broadcast in the cell. In FIG. 2, first network node 101a serves the first cell 103a, and the second network node 101b serves the second cell 103b. Any of the first network node 101a and the second network node 101b may be of different classes, such as, e.g., macro base station (BS), home BS or pico BS, based on transmission power and thereby also cell size. Any of the first network node 101a and the second network node 101b may be directly connected to one or more core networks, which are not depicted in FIG. 2 for the sake of simplicity. Any of the first network node 101a and the second network node 101n may be a distributed node, such as a virtual node in the cloud, and it may perform its functions entirely on the cloud, or partially, in collaboration with another network node. The first cell 103a may be referred to as a source cell, whereas the second cell 103b may be referred to as a target cell. When the reference number 103 is used herein without the letters a or b, it refers to a cell in general, i.e. it refers to any of the first cell 103a or second cell 103b.

One or a plurality of UEs 105 is comprised in the communication system 100. Only one UE 105 is exemplified in FIG. 2 for the sake of simplicity. A UE 105 may also be referred to simply as a device. The UE 105, e.g. an LTE UE or a 5G/NR UE, may be a wireless communication device which may also be known as e.g., a wireless device, a mobile terminal, wireless terminal and/or mobile station, a mobile telephone, cellular telephone, or laptop with wireless capability, just to mention some examples. The UE 105 may be a device by which a subscriber may access services offered by an operator's network and services outside operator's network to which the operator's radio access network and core network provide access, e.g. access to the Internet. The UE 105 may be any device, mobile or stationary, enabled to communicate over a radio channel in the communications system 100, for instance but not limited to e.g. UE, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC). The UE 105 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the communications system 100.

The UE 105 is enabled to communicate wirelessly within the communications system 100. The communication may be performed e.g. between two UEs 105, between a UE 105 and a regular telephone, between the UE 105 and a network node, between network nodes, and/or between the UE 105 and a server via the radio access network and possibly one or more core networks and possibly the internet.

The first network node 101a may be configured to communicate in the communications system 100 with the UE 105 over a first communication link 108a, e.g., a radio link. The second network node 101b may be configured to communicate in the communications system 100 with the UE 105 over a second communication link 108b, e.g., a radio link. The first network node 101a may be configured to communicate in the communications system 100 with the second network node 101b over a third communication link 108c, e.g., a radio link or a wired link, although communication over more links may be possible. When the reference number 108 is used herein without the letters a, b or c, it refers to a communication link in general, i.e. it refers to any of the first communication link 108a, the second communication link 108b and the third communication link 108c.

It should be noted that the communication links 108 in the communications system 100 may be of any suitable kind comprising either a wired or wireless link. The link may use any suitable protocol depending on type and level of layer (e.g. as indicated by the Open Systems Interconnection (OSI) model) as understood by the person skilled in the art.

In the text to follow, following terms are used to elaborate on the method(s) described herein:

Antenna panel: Antenna panel is a hardware installed on the UE 105 and network node 101 to transmit or receive radio signals during communication, positioning, and sensing procedures. An antenna panel may comprise more than one antenna element, where multiple antenna elements can be used for beamforming by the UE 105 to transmit and receive radio signals.

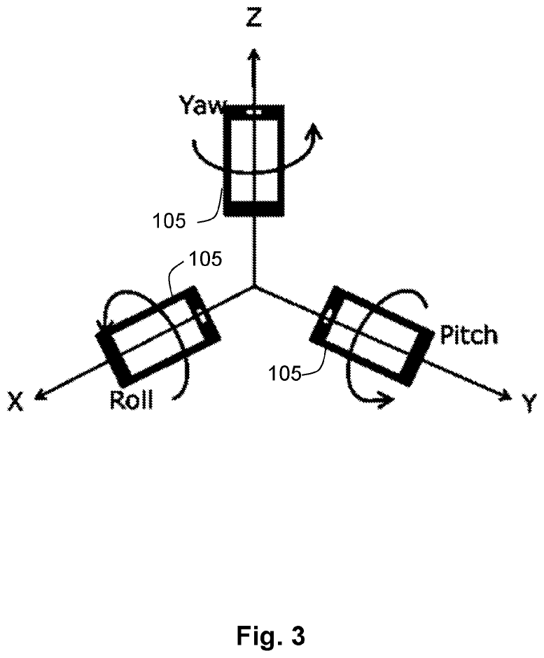

Orientation: Orientation is the heading of a UE 105 that determines angle between the antenna panel and the reference plane. Orientation indicates the direction towards which the antenna panel of the UE 105 is pointing at a given time with respect to the reference plane as shown in FIG. 3. FIG. 3 illustrates an example of the UE 105 and its orientation. The UE orientation can be in the following 3-dimensions: roll, pitch, and yaw.

UE 105: UE 105 is a device that can communicate with the network node 101. For example, mobile terminal in a cellular network that can communicate with the network node 101 for data exchange and/or transmitting and receiving reference signals for communication and for the purposes other than the communication such as positioning and sensing. UE 105, if equipped with, can also be configured by the network to report measurement from its sensors such as Gyroscope.

Network node 101: gNB, LMF, AMF that are part of the cellular network are referred to as network node. Network node 101 can receive measurement data from the UE 105, can configure UE 105 for reference signal transmission and reception, can configure/request UE 105 to report measurement from its sensors such as Gyroscope if the UE 105 reports availability of such sensors to the network node 101 during communication, positioning or a sensing procedure.

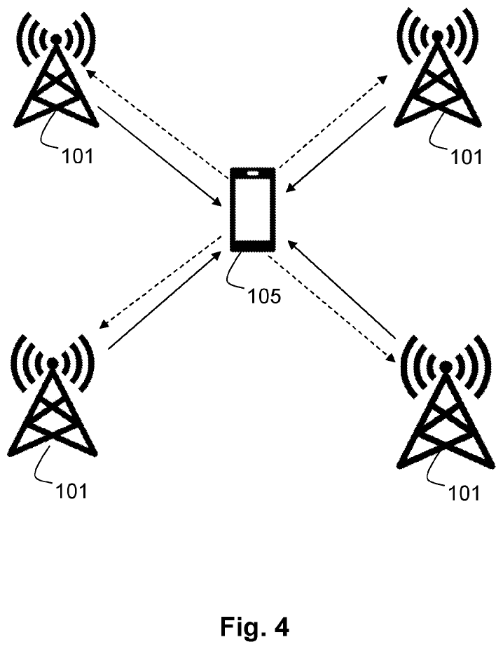

To elaborate on the present disclosure to estimate UE orientation, an example deployment as shown in FIG. 4 is considered. During positioning occasion, the UE 105 may receive reference signal for positioning measurement or transmit reference signal for positioning measurements to be done at the network node 101. Solid line indicates transmission of reference signal for positioning by TRP. Broken line indicates transmission of reference signal for positioning by UE. In this example in FIG. 4, a UE 105 and 4 TRPs are deployed. It is considered that UE 105 is configured to measure reference signal transmitted from the 4 TRPs and report measurements such as RSTD (difference of time of arrival (ToA) of reference signal from a reference TRP and a target TRP), RSRP (power of the received reference signal) of the reference signal from each TRP, and/or Rx-Tx time difference measurement corresponding to the reception time of reference signal from each TRP during a positioning occasion.

The term signal or radio signal used herein can be any physical signal or physical channel. Examples of DL physical signals are reference signal such as Primary Synchronization Signal (PSS), Secondary Synchronization Signal (SSS), Channel State Information Reference Signal (CSI-RS), Demodulation Reference Signal (DMRS), signals in Synchronization Signal Block (SSB), Demodulation Reference Signal (DRS), Cell specific reference signal (CRS), PRS, positioning reference signal for sidelink via the PC5 reference point etc.

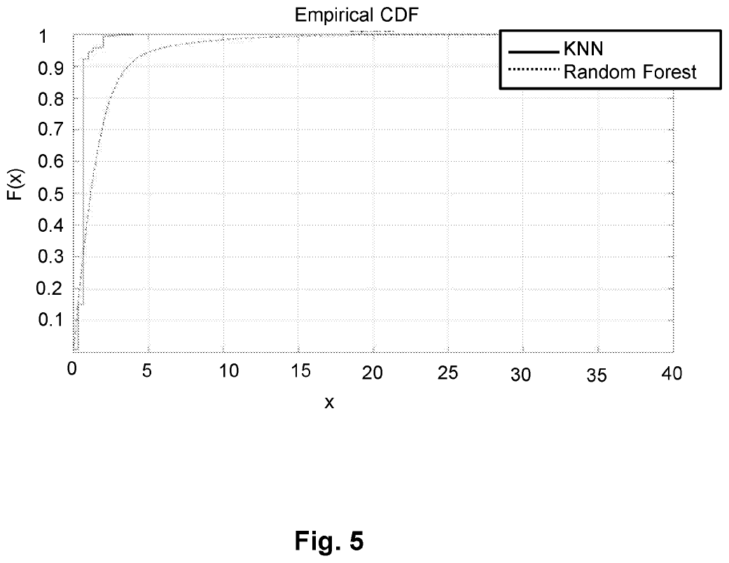

Assuming that the UE 105 reports, to the network node 101, PRS-RSRP during a positioning occasion in an indoor deployment such as indoor open office, the network node 101 can estimate the UE orientation by exploiting machine learning (ML) algorithm such as K-nearest neighbor (KNN) and Random Forest. The achievable orientation accuracy is shown in FIG. 5, where values in x-axis denote the error in orientation estimation in degrees and where the values in y-axis denote the percentile value for the corresponding error in x-axis. With reference to FIG. 3, in this example error in “yaw” estimation of the UE 105 is shown. The extension of the estimation to roll and pitch is not precluded.

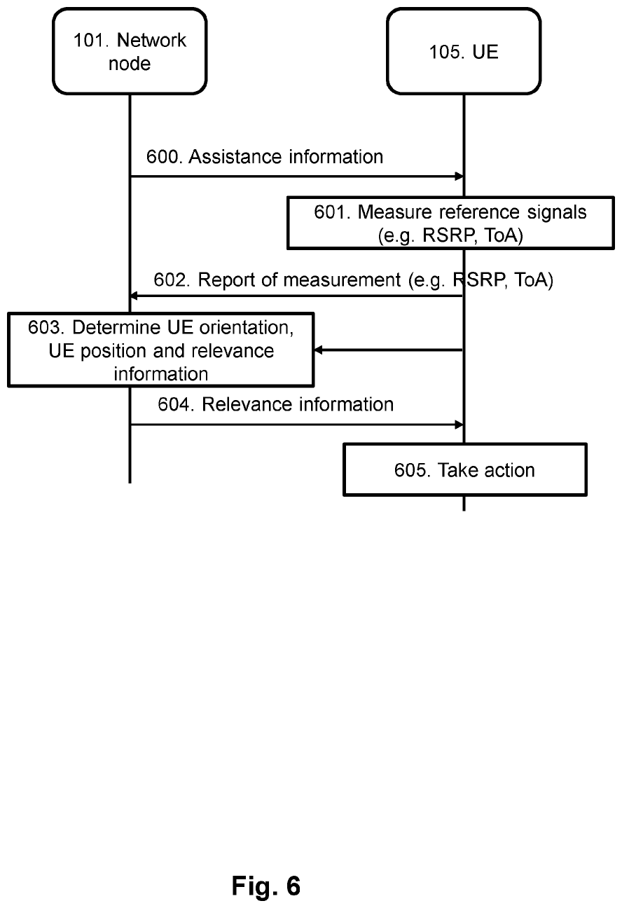

The method for handling information of relevance during a positioning occasion in a communications system 100 will now be described with reference to the signaling diagram depicted in FIG. 6. The method comprises at least one of the following steps, which steps may as well be carried out in another suitable order than described below.

### Step 600

The network node 101 provides assistance information to the UE 105. The UE 105 obtains the assistance information from the network node 101. The assistance information is related to positioning and/or information about a reference signal measurable by the UE 105. Assistance information relates to the information on signals that UE 105 can perform measurements on.

Step 600 may be triggered by that the network node 101 obtains capability information from the UE 105. Step 600 may be triggered by that the network node 101 already has the UE capability, for example if the UE 105 has sent its capability during previous positioning procedure, then the network node 101 may request the UE 105 to send the positioning measurement by sending the assistance data directly.

### Step 601

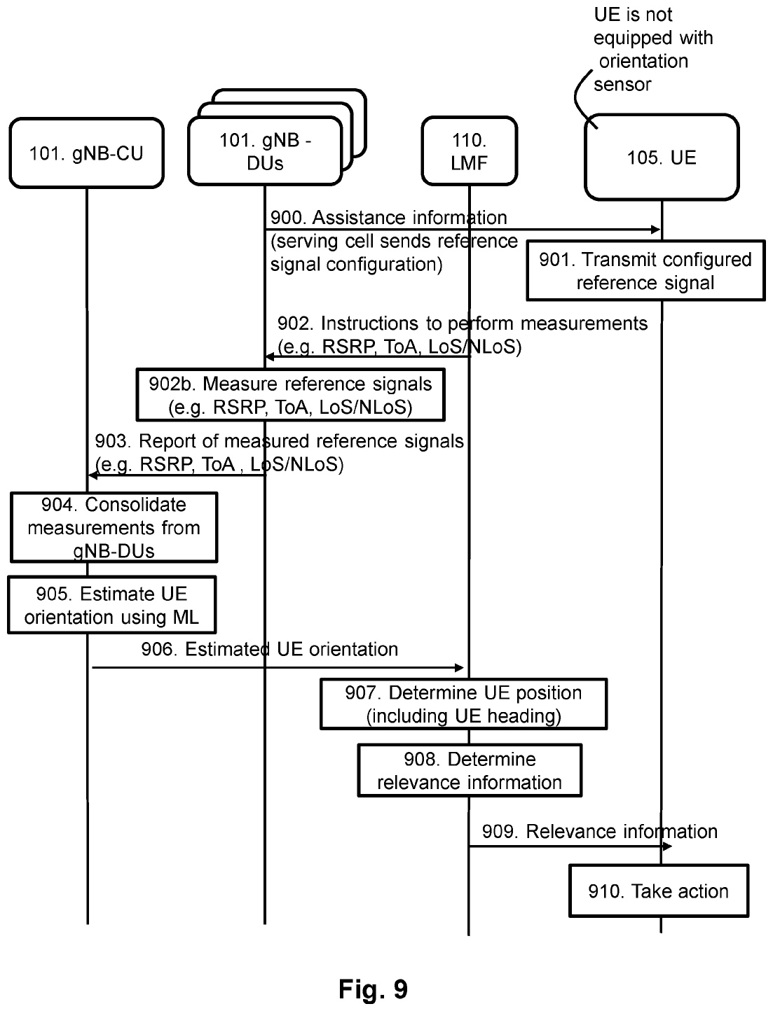

Triggered by receiving the assistance information in step 600, the UE 105 measures reference signals. The reference signals are measured from reference TRPs and target TRPs. The reference signals may be RSRP, ToA etc. Since the example in FIG. 6 is for the downlink, it is the UE 105 that performs the measurement. In uplink the gNB-DUs do the measurement, which will be described later with reference to FIG. 9.

### Step 602

The UE 105 provides, to the network node 101, a report of the measurement that was performed in step 601. The report may comprise for example RSRP, ToA etc.

Step 602 may be described as the UE provides positioning measurement information based on the measured reference signals to the network node 101.

### Step 603

The network node 101 determines, based on the received report of the measurement, UE orientation, UE position and relevance information. As mentioned above, the report of the measurement may be positioning measurement information. The UE orientation and the UE position may be determined by the network node 101 estimating the UE orientation and the UE position. Or the UE orientation and the UE position may be determined by the network node 101 receiving information indicating the UE orientation and UE position from the UE 105, i.e. the UE 105 may obtain its own UE orientation and UE position and may send it to the network node 101.

### Step 604

The network node 101 provides the information of relevance to the UE 105. The UE 105 obtains the information of relevance from the network node 101. The information of relevance is dependent on UE position in which the UE 105 is currently located and the UE orientation in which the UE 105 is currently orientated. The UE 105 receives the UE position, i.e. the current UE position, from the network node 101.

### Step 605

The UE 105 takes a necessary action, triggered by the received information of relevance or as indicated by the information of relevance. An example of an action may be that the UE 105 can orient itself to the right direction to change its position from the current position to a new position.

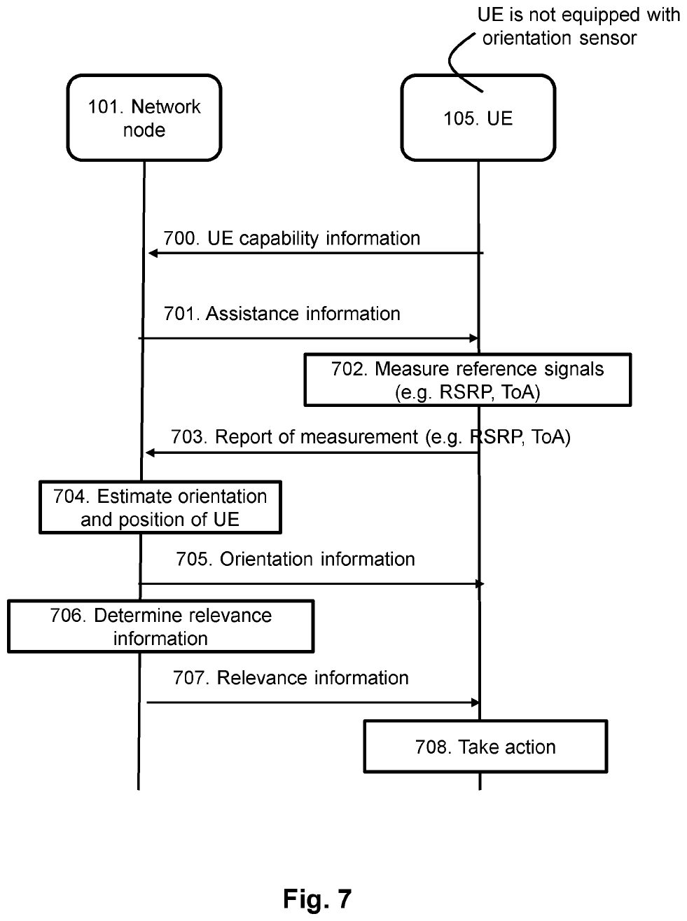

The method for handling information of relevance during a positioning occasion in a communications system 100 will now be described with reference to the signaling diagram depicted in FIG. 7. A positioning occasion may be described as or comprise determining the position of the UE 105. FIG. 7 illustrates an example where the UE 105 is not equipped with one or more orientation sensors or where the UE 105 does not utilize its one or more orientation sensors, for example due to malfunctioning, that they are busy, or for some other reason. UE orientation may be estimated by exploiting impact of UE orientation on radio signals as a feature and derive/use ML algorithm to predict the orientation of the UE 105. The method comprises at least one of the following steps, which steps may as well be carried out in another suitable order than described below:

### Step 700

The UE 105 provides UE positioning capability information to the network node 101. The network node 101 obtains the UE capability information from the UE 105. The UE positioning capability information indicates that the UE 105 is capable of performing position related measurements. The position related measurements may be one or more of:
RSTD; and/or
RSRP; and/or
Rx-Tx time difference measurement; and/or
RSRPP; and/or
Reference signal carrier phase difference (RSCPD); and/or
Reference signal carrier phase (RSCP); and/or
Providing Los or NIoS condition with TRPS in deployment.

### Step 701

This step corresponds to step 600 in FIG. 6. The network node 101 provides assistance information to the UE 105. The UE 105 obtains the assistance information from the network node 101. The assistance information is related to reference signals measurable by the UE 105. Assistance information relates to the information on signals that UE 105 can perform measurements on.

### Step 702

This step corresponds to step 601 in FIG. 6. Triggered by receiving the assistance information in step 701, the UE 105 measures reference signals. The reference signals may be RSRP, ToA etc. Since the example in FIG. 7 is for the downlink, it is the UE 105 that performs the measurement. In uplink the gNB-DUs do the measurement, which will be described later with reference to FIG. 9. The reference signals are measured from reference TRPS and target TRPs.

### Step 703

This step corresponds to step 602 in FIG. 6. The UE 105 provides, to the network node 101, a report of the measurement that was performed in step 702. The report may comprise for example RSRP, ToA etc. The report of the measurement may be positioning measurement information.

### Step 704

This step corresponds to step 603 in FIG. 6. The network node 101 estimates the UE orientation and the UE position. The estimation may be performed based on the report of the measurement from step 703. Using other words, the network node 101 determines the UE orientation based on the positioning measurement information.

### Step 705

The network node 101 provides the UE orientation information to the UE 105. The UE 105 obtains the UE orientation information from the network node 101. The UE 105 may use the UE orientation information in for example autonomous navigation or network controlled navigation, the UE may use this information to correctly orient itself towards the right direction etc.

### Step 706

This step corresponds to step 603 in FIG. 6. The network node 101 determines the information of relevance based on the estimated UE location in which the UE 105 is currently located and the estimated UE orientation in which the UE 105 is currently orientated. The term UE location and UE position may be used interchangeably herein.

### Step 707

This step corresponds to step 604 in FIG. 6. The network node 101 provides the information of relevance to the UE 105. The UE 105 obtains the information of relevance from the network node 101. The information of relevance is dependent on the UE position in which the UE is currently located and the UE orientation in which the UE 105 is currently orientated. The UE 105 receives the UE position, i.e. the current UE position, from the network node 101.

### Step 708

This step corresponds to step 605 in FIG. 6. The UE 105 takes a necessary action, triggered by the received information of relevance or as indicated by the information of relevance. An example of an action may be that the UE 105 may determine a new position and to can orient itself to the right direction to change its position from the current position to a new position.

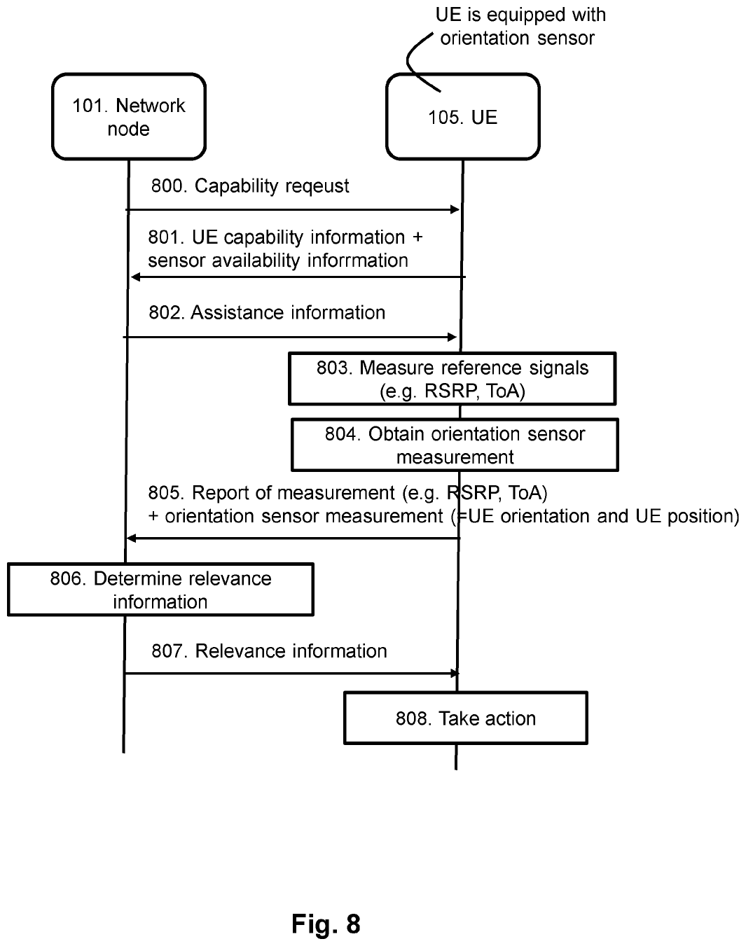

The method for handling information of relevance during a positioning occasion in a communications system 100 will now be described with reference to the signaling diagram depicted in FIG. 8. A positioning occasion may be described as or comprise determining the position of the UE 105. Compared the example in FIG. 7, the method exemplified in FIG. 8 may be seen as being more generic and works also for orientation estimation of UE 105 that has no gyroscope sensor. Step 8 illustrates an example where the UE 105 is equipped with and utilizes one or more orientation sensors. The method comprises at least one of the following steps, which steps may as well be carried out in another suitable order than described below:

### Step 800

The network node 101 may provide a capability request to the UE 105. The UE 105 may obtain the capability request from the network node 101.

### Step 801

This step corresponds to step 700 in FIG. 7. The UE 105 provides UE capability information to the network node 101, and possibly also orientation sensor availability information. The network node 101 obtains the UE capability information from the UE 105, and possibly also orientation sensor availability information.

### Step 802

This step corresponds to step 600 in FIG. 6 and step 701 in FIG. 7. The network node 101 provides assistance information to the UE 105. The UE 105 obtains the assistance information from the network node 101. The assistance information is related to positioning and/or information about a reference signal measurable by the UE 105. Assistance information relates to the information on signals that UE 105 can perform measurements on.

### Step 803

This step corresponds to step 601 in FIG. 6 and step 702 in FIG. 7. Triggered by receiving the assistance information in step 802, the UE 105 measures reference signals. The reference signals may be RSRP, ToA etc. The reference signals are measured from reference TRPs and target TRPs. Since the example in FIG. 6 is for the downlink, it is the UE 105 that performs the measurement. In uplink the gNB-DUs do the measurement, which will be described later with reference to FIG. 9.

### Step 804

The UE 105 obtains UE orientation sensor measurements from its one or more UE orientation sensors. The one or more UE orientation sensor may be comprised in or mounted on the UE 105, or it may be associated with the UE 105 in some other way, for example connected with a wireless communication link etc. The UE orientation sensor measurement may comprise the UE orientation, or the UE position or both the UE orientation and the UE position,

### Step 805

This step corresponds to step 602 in FIG. 6 and step 703 in FIG. 7. The UE 105 provides, to the network node 101, a report of the measurement that was performed in step 803. The report may comprise for example RSRP, ToA etc. Using other words, the UE 105 provides orientation sensor measurement information, for example together with measurement information.

The UE 105 provides, to the network node 101, a report of the orientation sensor measurement that was performed in step 804, for example the UE orientation or the UE position, or both.

### Step 806

This step corresponds to step 603 in FIG. 6 and step 706 in FIG. 7. The network node 101 determines the information of relevance. The information of relevance is dependent on UE position in which the UE 105 is currently located and the UE orientation in which the UE 105 is currently orientated.

### Step 807

This step corresponds to step 604 in FIG. 6 and step 707 in FIG. 7. The network node 101 provides the information of relevance to the UE 105. The UE 105 obtains the information of relevance from the network node 101. The information of relevance is dependent on UE position in which the UE 105 is currently located and UE orientation in which the UE 105 is currently orientated. The UE 105 receives the UE position, i.e. the current UE position, from the network node 101.

### Step 808

This step corresponds to step 605 in FIG. 6 and step 708 in FIG. 7. The UE 105 takes a necessary action, triggered by the received information of relevance or as indicated by the information of relevance. An example of an action may be that the UE 105 can orient itself to the right direction to change its position from the current position to a new position.

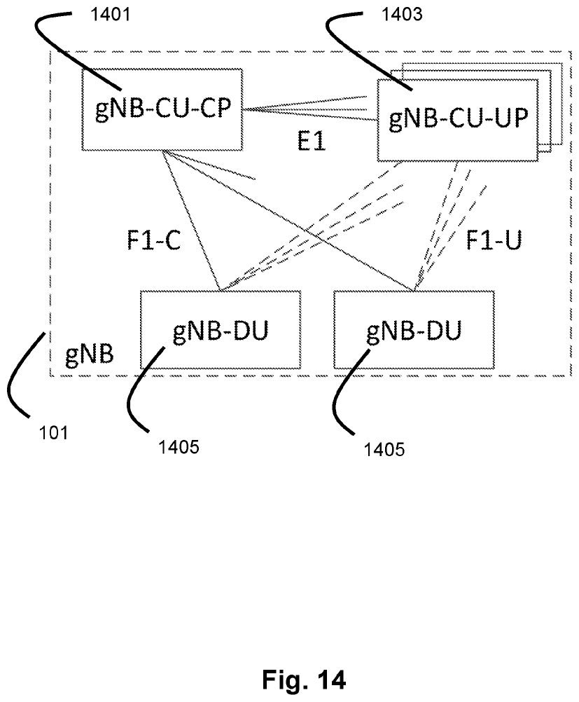

The method for handling information of relevance during a positioning occasion in a communications system 100 will now be described with reference to the signaling diagram depicted in FIG. 9. A positioning occasion may be described as or comprise determining the position of the UE 105. FIG. 9 illustrates an example where the network node 101 comprises a network node-CU-CP, multiple network node CU-Ups and multiple network node-Dus. The network node CU-CP may be for example a gNB-CU, the network node-Dus may be for example gNB-Dus. The terms gNB-CU and gNB-DU will be used below as examples. DU is short for Distributed Unit, CU is short for Central Unit and CP is short for Control Plane. More details regarding the units that the network node 101 comprises will be provided later with reference to FIG. 14. The method comprises at least one of the following steps, which steps may as well be carried out in another suitable order than described below:

### Step 900

This step corresponds to step 600 in FIG. 6, step 701 in FIG. 7 and step 802 in FIG. 8. The gNB-DU 101 comprised in the serving cell provides assistance information to the UE 105. The assistance information comprises reference signal configuration. The assistance information is related to positioning and/or information about a reference signal measurable by the UE 105. Assistance information relates to the information on signals that UE 105 can perform measurements on.

The gNB-DU 101 that is comprised in the serving cell may be described as the gNB-DU amongst the multiple gNB-DUS that is currently serving the UE 105 when it is in the serving cell, i.e. the current location, the current cell. This means that it is only one of the multiple gNB-Dus 101 that provides the assistance information to the UE 105.

The UE 105 obtains the assistance information from the gNB-DU 101.

### Step 901

When the UE 105 has received the assistance information in step 900, the UE 105 starts to transmit the configured reference signal.

### Step 902

The LMF 110 provides instructions to perform measurements of reference signals to all gNB-Dus 101. The measurements may be to measure one or more of e.g. RSRP, ToA, LoS/NIoS.

### Step 902b

As a result of the received instructions in step 902, each gNB-Dus in the multiple gNB-Dus 101 performs the measurements of the reference signals transmitted by the UE 105. The measured reference signals may be one or more of: RSRP, ToA, LoS/NIoS etc.

Step 902b is a difference compared to what is exemplified in FIGS. 6-8. In FIGS. 6-8, the UE 105 performs the measurements of the reference signals, while in FIG. 9, it is the gNB-DU 101 that performs the measurements of the reference signal. The difference is if the measurement is done in downlink or in uplink. In downlink, the UE 105 does the measurement. In uplink the gNB-Dus do the measurement.

### Step 903

Each gNB-DU in the multiple gNB-Dus 101 provides a report of the measurements to the gNB-CU 101. The report of the measurements may comprise one or more of e.g. RSRP, ToA, LoS/NIoS. The gNB-CU 101 obtains multiple reports of measured reference signal, one report from each gNB-DU 101.

### Step 904

The gNB-CU 101 consolidates the measurements from all gNB-Dus 101 that it obtained in step 903.

### Step 905

The gNB-CU 101 estimates the UE orientation based on the consolidated measurements and using Machine Learning.

### Step 906

The gNB-CU 101 provides the estimated UE orientation to the LMF 110. The LMF 110 obtains the estimated UE orientation from the gNB-CU 101.

### Step 907

By using the estimated UE orientation, the LMF 110 determines the UE position, possibly including the UE heading.

### Step 908

This step corresponds to step 603 in FIG. 6, step 706 in FIG. 7 and step 806 in FIG. 8. The LMF 110 determines information of relevance based on the determined UE position, and possibly including the UE heading from step 907. The information of relevance is dependent on the UE position in which the UE 105 is currently located and the UE orientation in which the UE 105 is currently orientated.

### Step 909

This step corresponds to step 604 in FIG. 6, step 707 in FIG. 7 and step 807 in FIG. 8. The LMF 110 provides the information of relevance to the UE 105. The information of relevance is dependent on UE position in which the UE 105 is currently located and UE orientation in which the UE 105 is currently orientated. The UE 105 receives the UE position, i.e. the current UE position, from the network node 101.

### Step 910

This step corresponds to step 605 in FIG. 6, step 708 in FIG. 7 and step 808 in FIG. 8. This step corresponds to step The UE 105 takes an action based on the information of relevance or as indicated in the information of relevance. An example of an action may be that the UE 105 can orient itself to the right direction to change its position from the current position to a new position.

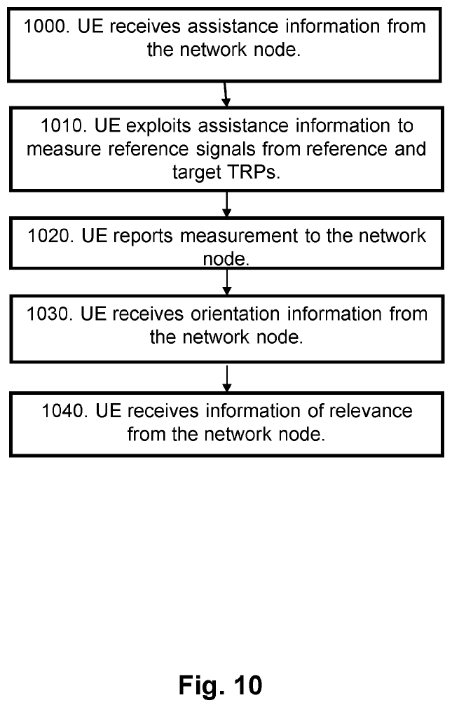

The method described above will now be described seen from the perspective of the UE 105. FIG. 10 is a flowchart describing the present method in the UE 105 for handling information of relevance during a positioning occasion in a communications system 100. A positioning occasion may be described as or comprise determining the position of the UE 105. During the positioning occasion, the network node 101 sends the assistance information to UE 105. The assistance information, among other information, consists of DL PRS configuration of reference and target TRPs. The UE 105 reports positioning measurements such as RSTD, PRS-RSRP and UE Rx-Tx based on the DL PRS received from reference and target TRPs. During the positioning occasion the UE orientation has an impact on the measurement value. The impact is even more prominent on the measurement such as RSRP of the reference signal. The UE reported RSRP value can be used to predict the orientation of the UE 105 when the measurement was done. Therefore, in this embodiment, UE orientation is estimated by the network node 101 after the RSRP values of target TRPs and reference TRP are reported by the UE during a positioning occasion. The network node 101 can exploit the trained ML algorithms to estimate the UE orientation in a given deployment. The method exemplified in FIG. 10 comprises at least one of the following steps to be performed by the UE 105, which steps may be performed in any suitable order than described below:

Step 1000: This step corresponds to step 600 in FIG. 6, step 701 in FIG. 7, in step 802 and step 900 in FIG. 9. The UE 105 receives assistance information from the network node 101. Assistance information could be related to positioning or information about reference signal that UE 105 can measure for orientation estimation. The assistance information is related to positioning and/or information about a reference signal measurable by the UE 105. Assistance information relates to the information on signals that UE 105 can perform measurements on.

Step 1010: This step corresponds to step 601 in FIG. 6, step 702 in FIG. 7, step 803 in FIG. 8 and step 901 in FIG. 9. The UE 105 exploits assistance information to measure reference signals from reference and target TRPs. Reference could be reference signal for positioning via Uu interface, reference signal for sidelink based positioning via PC5.

Step 1020: This step corresponds to step 602 in FIG. 6, step/703 in FIG. 7, step 805 in FIG. 8 and steps 902-903 in FIG. 9. The UE 105 reports the measurement to the network node 101. The measurement could be for positioning purposes such PRS-RSRP. Other positioning measurements such as ToA are not precluded. Measurements specific to orientation estimation could be RSRP of reference signal for positioning for sidelink via PC5. The measurement may also include LoS or NLoS condition of UE with all TRPs in the deployment. The measurement may be positioning measurement information and is based on the measured reference signals.

Step 1030: This step corresponds to steps 603 and 605 in FIG. 3 and steps 705 and 708 in FIG. 7, step 808 in FIG. 8 and step 910 in FIG. 9. The UE 105 receives orientation information from the network node 101. Based on the UE reported measurements, the network node 101 estimates the orientation of the UE 105 and the estimated UE orientation may be transferred to UE 105. Depending on the received orientation information UE may exploit it to take further actions.

Step 1040: This step corresponds to steps 604-605 in FIG. 6, steps 707-708 in FIG. 7, steps 807-808 in FIG. 8 and steps 909-910 in FIG. 9. The UE 105 receives information of relevance from the network node 101. The information of relevance is dependent on the UE position in which the UE 105 is currently located and UE orientation in which the UE 105 is currently orientated.

The UE 105 receives the UE position, i.e. the current UE position, from the network node 101. Based on the UE reported measurements, the network node 101 estimates the orientation and location of the UE 105. The network node 101 may use this information to provide information of relevance to the UE 105. The information of relevance could be navigation instruction based on which UE 105 may change its position to new position and gets remotely navigated to its destination. The information of relevance could be augmented data based on the UE orientation and its location. The information of relevance could be the estimated location and orientation of the UE that UE 105 may further exploit to take further actions.

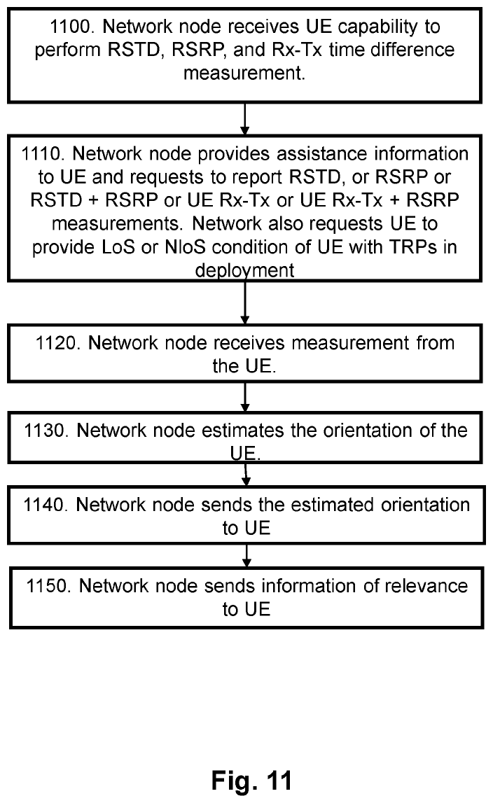

The method described above will now be described seen from the perspective of the network node 101. FIG. 11 is a flowchart describing the present method in the network node 101, corresponding to the method in FIG. 10, for handling information of relevance during a postponing occasion in a communications system 100. The method exemplified in FIG. 11 comprises at least one of the following steps to be performed by the network node 101, which steps may be performed in any suitable order than described below:

Step 1100: This step corresponds to step 700 in FIG. 7 and step 801 in FIG. 8. The network node 101 receives UE positioning capability information from the UE 105. The UE positioning capability is the UE's capability to perform one or more of the following: RSTD, RSRP, Rx-Tx time difference, RSRPP, RSCPD, RSCP measurement, providing Los or NIoS condition with TRPS in deployment. The UE reported capability does not preclude capability response in positioning via sidelink reference signal.

Step 1110: This step corresponds to step 600 in FIG. 6, step 701 in FIG. 7, in step 802, step 900 in FIG. 9 and step 1000 in FIG. 10. Network node 101 provides assistance information to UE 105 and requests to report RSTD, or RSRP or RSTD+RSRP or UE Rx-Tx or UE Rx-Tx+RSRP measurements. Network node 101 also requests UE 105 to provide LoS or NIoS condition of UE with TRPs in deployment. The assistance information is related to positioning and/or information about a reference signal measurable by the UE 105. The assistance information is related to positioning and/or information about a reference signal measurable by the UE 105. Assistance information relates to the information on signals that UE 105 can perform measurements on.

Step 1120: This step corresponds to step 602 in FIG. 6, step 703 in FIG. 7, step 805 in FIG. 8, steps 902-903 in FIG. 9 and step 1020 in FIG. 10. The network node 101 receives positioning measurement information from the UE 105.

Step 1130: Network node 101 estimates the orientation of the UE 105. In other words, the network node 101 determines the UE orientation based on the positioning measurement information from step 1120.

Step 1140: This step corresponds to steps 603 and 605 in FIG. 3 and steps 705 and 708 in FIG. 7, step 808 in FIG. 8, step 910 in FIG. 9 and step 1030 in FIG. 10. Network node 101 sends the estimated orientation to UE 105. After estimating the UE orientation, network node 101 may transfer it to UE 105 for it to take further action based on the orientation information.

Step 1150: This step corresponds to steps 604-605 in FIG. 6, steps 707-708 in FIG. 7, steps 807-808 in FIG. 8, steps 909-910 in FIG. 9 and step 1040 in FIG. 10. Network node 101 sends information of relevance to UE 105. The information of relevance is dependent on UE position and in which the UE 105 is currently located and the UE orientation in which the UE 105 is currently orientated. Based on the UE reported measurements network estimates the orientation and location of the UE. The network node 101 may use this information to provide information of relevance to the UE. The information of relevance could be navigation instruction based on which UE 105 may change its position to new position and gets remotely navigated to its destination. The information of relevance could be augmented data based on the UE orientation and its location. The information of relevance could be the estimated location and orientation of the UE 105 that UE 105 may further exploit to take further actions.

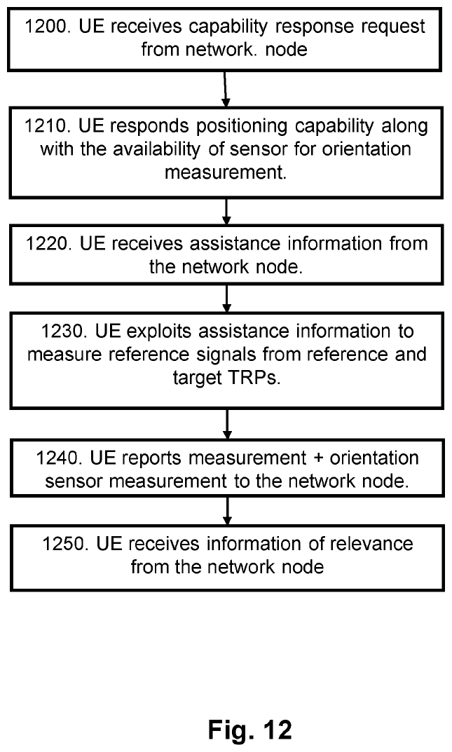

The method described above will now be described seen from the perspective of the UE 105. FIG. 12 is a flowchart describing the present method in the UE 105 for handling information of relevance during a positioning occasion in a communications system 100. A positioning occasion may be described as or comprise determining the position of the UE 105. In the example of FIG. 12, a UE 105 equipped with sensor that can be used for orientation estimation is considered. During the capability transfer procedure, for example during positioning capability transfer to the network node 101 as a response to network node 101 to request for capability, the UE 105 may indicate availability of sensor for orientation estimation. Based on the UE reported capability, network node 101 may configure and request the UE 105 to report its orientation sensor measurement along with the positioning measurements during a positioning occasion. UE 105 may report the orientation sensor measurement to its serving gNB 101 or to the location server via LPPa protocol. The method exemplified in FIG. 12 comprises at least one of the following steps to be performed by the UE 105, which steps may be performed in any suitable order than described below:

Step 1200: This step corresponds to step 800 in FIG. 8. The UE 105 receives capability response request from network node 101.

Step 1210: This step corresponds to step 700 in FIG. 7 and step 801 in FIG. 8. The UE 105 responds with the UE positioning capability information along with the availability of sensor for orientation measurement. The UE positioning capability information indicates that the UE 105 is capable of performing position related measurements such as one or more of the following:
RSTD; and/or
RSRP; and/or
Rx-Tx time difference measurement; and/or
RSRPP; and/or
RSCPD; and/or
RSCP; and/or
Providing Los or NIoS condition with TRPS in deployment.

Step 1220: This step corresponds to step 600 in FIG. 6, step 701 in FIG. 7, in step 802, step 900 in FIG. 9, step 1000 in FIG. 10 and step 1110 in FIG. 11. The UE 105 receives assistance information from the network node 101. The assistance information is related to positioning and/or information about a reference signal measurable by the UE 105. Assistance information relates to the information on signals that UE 105 can perform measurements on.

Step 1230: This step corresponds to step 601 in FIG. 6, step 702 in FIG. 7, step 803 in FIG. 8, step 901 in FIG. 9 and step 1010 in FIG. 10. UE 105 exploits assistance information to measure reference signals from reference and target TRPs.

Step 1240: This step corresponds to step 602 in FIG. 6, step 703 in FIG. 7, step 805 in FIG. 8. Steps 902-903 in FIG. 9 and step 1020 in FIG. 10. UE 105 reports measurement+orientation sensor measurement to the network node 101.

Step 1250: This step corresponds to steps 604-605 in FIG. 6, steps 707-708 in FIG. 7, steps 807-808 in FIG. 8, steps 909-910 in FIG. 9 and step 1040 in FIG. 10. After reporting the orientation measurement and the measurements for positioning, UE 105 may receive information of relevance from the network node 101. The information of relevance could be navigation instruction based on which UE 105 may change its position to new position and gets remotely navigated to its destination. The information of relevance could be augmented data based on the UE orientation and its location. The information of relevance could be the estimated location and orientation of the UE 105 that UE 105 may further exploit to take further actions. The UE 105 receives the UE position, i.e. the current UE position, from the network node 101.

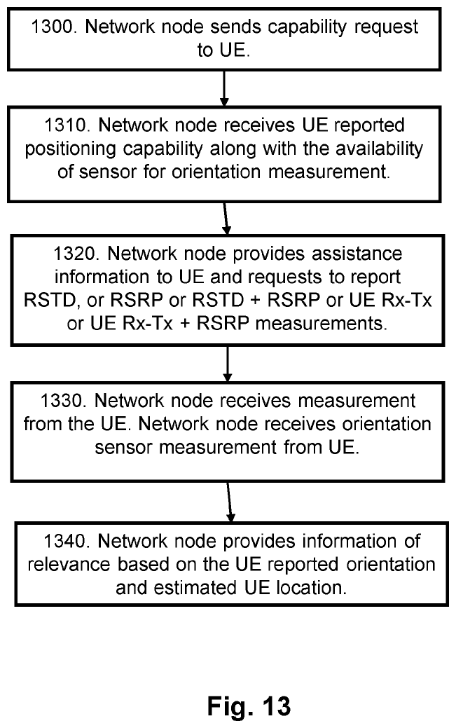

The method described above will now be described seen from the perspective of the network node 101. FIG. 13 is a flowchart describing the present method in the network node 101, corresponding to the method in FIG. 12, for handling information of relevance during a positioning occasion in a communications system 100. A positioning occasion may be described as or comprise determining the position of the UE 105. The method exemplified in FIG. 13 comprises at least one of the following steps to be performed by the network node 101, which steps may be performed in any suitable order than described below:

Step 1300: This step corresponds to step 800 in FIG. 8 and step 1200 in FIG. 12. Network node sends a capability request to UE 105, i.e. a request for UE positioning capability information.

Step 1310: This step corresponds to step 700 in FIG. 7, step 801 in FIG. 8, step 1100 in FIG. 11, step 1210 in FIG. 12. Network node 101 receives UE reported positioning capability along with the availability of sensor for orientation measurement.

Step 1320: This step corresponds to step 600 in FIG. 6, step 701 in FIG. 7, step 802 in FIG. 8, step 900 in FIG. 9, step 1000 in FIG. 10, step 1110 in FIG. 11 and step 1220 in FIG. 12. Network node 101 provides assistance information to UE 105 and requests to report RSTD, or RSRP or RSTD+RSRP or UE Rx-Tx or UE Rx-Tx+RSRP measurements. The assistance information is related to positioning and/or information about a reference signal measurable by the UE 105. Assistance information relates to the information on signals that UE 105 can perform measurements on.

Step 1330: This step corresponds to step 602 in FIG. 6, step 703 in FIG. 7, step 805 in FIG. 8, steps 902-903 in FIG. 9, step 1020 in FIG. 10, step 1120 in FIG. 11 and step 1240 in FIG. 12. Network node 101 receives positioning measurement information from the UE 105. Network node 101 receives orientation sensor measurement from UE 105. The positioning measurement information is based on reference signals from reference TRPs and target TRPs.

Step 1340: This step corresponds to step 604-605 in FIG. 6, steps 707-708 in FIG. 7, steps 807-808 in FIG. 8, steps 909-910 in FIG. 9, step 1040 in FIG. 10, step 1150 in FIG. 11 and step 1250 in FIG. 12. Network node 101 provides information of relevance based on the UE reported orientation and estimated UE location. After receiving the measurement from UE, network estimates the UE location and determines the UE orientation based on UE reported orientation sensor measurement. After determining the UE location and orientation, the network node 101 provides information of relevance to the UE 105. The information of relevance could be navigation instruction based on which UE 105 may change its position to new position and gets remotely navigated to its destination. The information of relevance could be augmented data based on the UE orientation and its location. The information of relevance could be the estimated location and orientation of the UE 105 that UE 105 may further exploit to take further actions.

The overall architecture for separation of gNB-CU-CP 1401 and gNB-CU-UP 1403 is depicted in FIG. 14. FIG. 14 uses an gNB as an example of a network node 101.

A gNB may comprise a gNB-CU-CP 1401, multiple gNB-CU-Ups 1403 and multiple gNB-Dus 1405;
The gNB-CU-CP is arranged to be connected to the gNB-DU through the F1-C interface;
The gNB-CU-UP is arranged to be connected to the gNB-DU through the F1-U interface;
The gNB-CU-UP is arranged to be connected to the gNB-CU-CP through the E1 interface;
One gNB-DU is arranged to be connected to only one gNB-CU-CP;
One gNB-CU-UP is arranged to be connected to only one gNB-CU-CP. For resiliency, a gNB-DU and/or a gNB-CU-UP may be arranged to be connected to multiple gNB-CU-CPs by appropriate implementation.
One gNB-DU can be arranged to be connected to multiple gNB-CU-Ups under the control of the same gNB-CU-CP.
One gNB-CU-UP can be arranged to be connected to multiple Dus under the control of the same gNB-CU-CP;

The connectivity between a gNB-CU-UP and a gNB-DU is established by the gNB-CU-CP using Bearer Context Management functions.

The gNB-CU-CP selects the appropriate gNB-CU-UP(s) for the requested services for the UE 105. In case of multiple CU-Ups they belong to same security domain.

Data forwarding between gNB-CU-Ups during intra-gNB-CU-CP handover within a gNB 101 may be supported by Xn-U.

Depending on the deployment, a gNB 101 may have multiple DU and one CU as shown in FIG. 14. This type of deployment may be suitable for e.g. indoor deployments such as indoor open office or indoor factory for IioT use cases. In such a deployment during the positioning occasion, mainly when UE 105 is transmitting the reference signal and gNB 101 is performing the positioning measurements, measurement such as ToA, RSRP from different Dus can be consolidated in gNB-CU where the ML algorithm can be implemented for UE orientation estimation. In this case, the gNB 101 reports the positioning measurement along with the estimated UE orientation to LMF. Based on the gNB reported measurements, the network, e.g. represented by the LMF 110, can estimate the UE location. The network node 101 may use UE location+orientation information to provide information of relevance to the UE 105. The information of relevance could be navigation instruction based on which UE may change its position to new position and gets remotely navigated to its destination. The information of relevance could be augmented data based on the UE orientation and its location. The information of relevance could be the estimated location and orientation of the UE 105 that UE 105 may further exploit to take further actions.

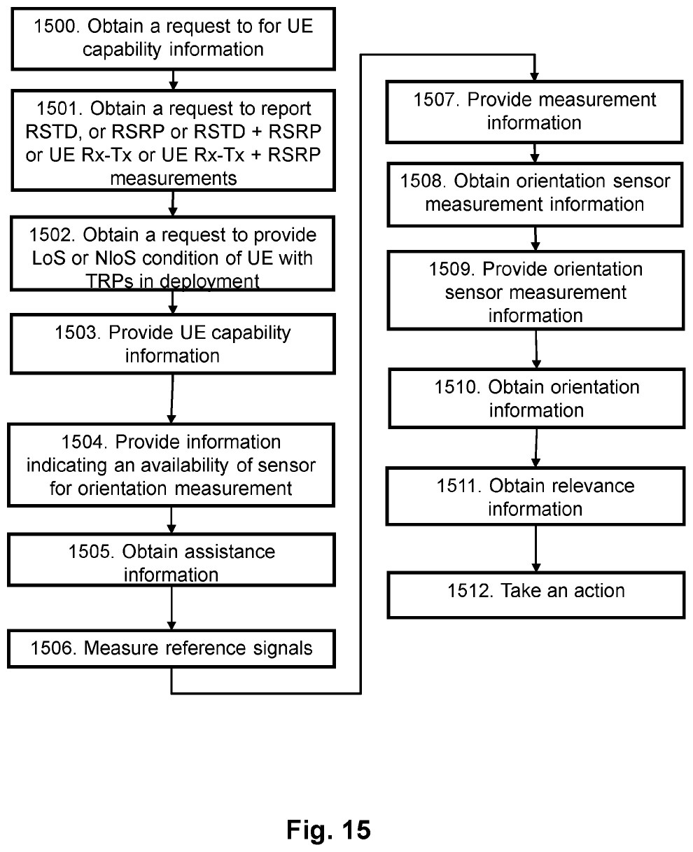

The method described above will now be described seen from the perspective of the UE 105. FIG. 15 is a flowchart describing the present method in the UE 105 for handling information of relevance during a positioning occasion in a communications system 100. A positioning occasion may be described as or comprise determining the position of the UE 105. The UE 105 may comprise and/or is associated with one or more sensors adapted for UE orientation measurements. The UE 105 may be at an outdoor location or at an indoor location. The method comprises at least one of the following steps to be performed by the UE 105, which steps may be performed in any suitable order than described below:

### Step 1500

This step corresponds to step 800 in FIG. 8 and step 1200 in FIG. 12. The UE 105 may obtain, from the network node 101, a request for UE positioning capability information.

### Step 1501

This step corresponds to step 800 in FIG. 8 and step 1200 in FIG. 12. The UE 105 may obtain, from the network node 101, a request to report RSTD, or RSRP or RSTD+RSRP or UE Rx-Tx or UE Rx-Tx+RSRP measurements.

### Step 1502

This step corresponds to step 800 in FIG. 8 and step 1200 in FIG. 12. The UE 105 may obtain, from the network node 101, a request to provide LoS or NIoS condition of UE with TRPs in deployment.

### Step 1503

This step corresponds to step 700 in FIG. 7, step 801 in FIG. 8 and step 1210 in FIG. 12. The UE 105 may provide UE positioning capability information to the network node 101. The UE positioning capability information may indicate that the UE 105 is capable of performing one or more of: RSTD and/or RSRP and/or Rx-Tx time difference measurement and/or RSRPP and/or RSCPD and/or RSCP and/or providing LoS or NIoS condition with TRPs in deployment.

### Step 1504

This step corresponds to step 801 in FIG. 8 and step 1210 in FIG. 12. The UE 105 may provide, to the network node 101, information indicating an availability of sensor for orientation measurement. The information may be provided for example together with UE capability information.

### Step 1505

This step corresponds to step 600 in FIG. 6, step 701 in FIG. 7, step 802 in FIG. 8, step 900 in FIG. 9, step 1000 in FIG. 10 and step 1220 in FIG. 12. The UE 105 obtains assistance information from a network node 101.

The assistance information may be related to positioning and/or information about reference signal that UE 105 can measure for orientation estimation. Assistance information relates to the information on signals that UE 105 can perform measurements on.

### Step 1506

This step corresponds to step 601 in FIG. 6, step 702 in FIG. 7, step 803 in FIG. 8, step 1010 in FIG. 10 and step 1230 in FIG. 12. The UE 105 measures reference signals based on the assistance information.

The reference signals may be measured from reference TRP and target TRPs.

The reference TRPs may comprise a reference signal for positioning via Uu interface and/or a reference signal for sidelink based positioning via PC5.

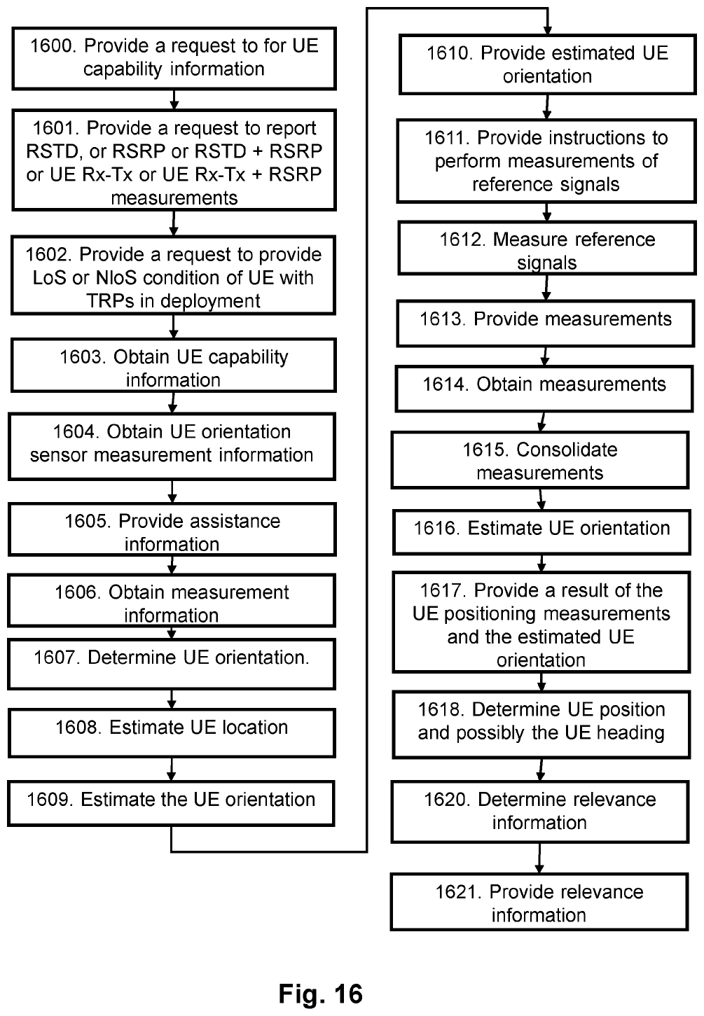

The measuring may be one or more of the following:
for positioning purposes such as, PRS-RSRP and/or ToA.
specific to orientation estimation such as RSRP of reference signal for positioning for sidelink via PC5, and/or
wherein the measuring comprises LoS and/or NIoS condition of UE with all TRPs in the deployment.
   Step 1506 may be performed for downlink, and therefore it is the UE 105 that performs the measurement. In uplink, the gNB-DUs do the measurement, which will be described later with reference to FIG. 16.

### Step 1507

This step corresponds to step 602 in FIG. 6, step 703 in FIG. 7, step 805 in FIG. 8, step 1020 in FIG. 10 and step 1240 in FIG. 12. The UE 105 provides positioning measurement information to the network node 101.

The positioning measurement information may comprise measurements of reference signal from reference and target TRPs.

### Step 1508

This step corresponds to step 804 in FIG. 8. The UE 105 may obtain, from one or more orientation sensors associated with the UE 105, orientation sensor measurement information indicating orientation of the UE 105.

### Step 1509

This step corresponds to step 805 in FIG. 8 and step 1240 in FIG. 12. The UE 105 may provide, to the network node 101, orientation sensor measurement information, for example together with the positioning measurement information.

### Step 1510

This step corresponds to step 705 in FIG. 7. The UE 105 may obtain orientation information from the network node 101. The orientation information may have been estimated by the network node 101.

### Step 1511

This step corresponds to step 604 in FIG. 6, step 707 in FIG. 7, step 807 in FIG. 8, step 909 in FIG. 9, step 1040 in FIG. 10 and step 1250 in FIG. 12. The UE 105 obtains information of relevance from the network node 101. The information of relevance is dependent on a UE position in which the UE 105 is currently located and UE orientation in which the UE 105 is currently orientated. The UE 105 receives the UE position, i.e. the current UE position, from the network node 101.

The relevance information may comprise one or more of the following:
navigation instruction based on which UE 150 may change its position to new position and gets remotely navigated to its destination; and/or
augmented data based on the UE orientation and its location; and/or
the estimated location and orientation of the UE 105 that UE 105 may further exploit to take further actions.

### Step 1512

This step corresponds to step 605 in FIG. 6, step 708 in FIG. 7, step 808 in FIG. 8 and step 910 in FIG. 9. The UE 105 may take an action based on the obtained information of relevance.

The method described above will now be described seen from the perspective of the network node 101. FIG. 16 is a flowchart describing the present method in the network node 101 for handling information of relevance during a positioning occasion in a communications system 100. A positioning occasion may be described as or comprise determining the position of the UE 105. The network node 101 may comprises:
a network node CU-CP 1401, e.g. gNB-CU-CP; and/or
one or more network node network node CU-UP 1403, e.g. gNB-CU-UP; and/or
one or more network node DU 1405, e.g. gNB-DU.

The method comprises at least one of the following steps to be performed by the network node 101, which steps may be performed in any suitable order than described below:

### Step 1600

This step corresponds to step 800 in FIG. 8 and step 1300 in FIG. 13. The network node 101 may provide, to the UE 105, a request to for UE positioning capability information.

### Step 1601

This step corresponds to step 800 in FIG. 8 and step 1300 in FIG. 13. The network node 101 may provide, to the UE 105, a request to report RSTD, or RSRP or RSTD+RSRP or UE Rx-Tx or UE Rx-Tx+RSRP measurements.

### Step 1602

This step corresponds to step 800 in FIG. 8 and step 1300 in FIG. 13. The network node 101 may provide, to the UE 105, a request to provide LoS or NIoS condition of UE with TRPs in deployment.

### Step 1603

This step corresponds to step 700 in FIG. 7, step 801 in FIG. 8, step 1100 in FIG. 11 and step 1310 in FIG. 13. The network node 101 may obtain_UE positioning capability information from the UE 105. The UE positioning capability information may indicate that the UE 105 is capable of performing position related measurements, for example one or more of: RSTD and/or RSRP and/or Rx-Tx time difference measurement and/or RSRPP and/or RSCPD and/or RSCP and/or providing LoS or NIoS condition with TRPs in deployment.

### Step 1604

This step corresponds to step 805 in FIG. 8 and step 1330 in FIG. 13. The network node 101 may obtain, from the UE 105, UE orientation sensor measurement information.

### Step 1605

This step corresponds to step 600 in FIG. 6, step 701 in FIG. 7, step 802 in FIG. 8, step 900 in FIG. 9, step 1110 in FIG. 11, step 1220 in FIG. 12 and step 1320 in FIG. 13. The network node 101 provides assistance information to the UE 105. The assistance information is related to reference signals measurable by the UE 105. Assistance information relates to the information on signals that UE 105 can perform measurements on.

### Step 1606

This step corresponds to step 602 in FIG. 6, step 703 in FIG. 7, step 805 in FIG. 8, step 1120 in FIG. 11, step 1230 in FIG. 12 and step 1330 in FIG. 13. The network node 101 obtains positioning measurement information from the UE 105. The positioning measurement information is based on the measured reference signals.

The positioning measurement information may comprise measurements of reference signal from reference and target TRPs.

### Step 1607

This step corresponds to step 603 in FIG. 6, step 704 in FIG. 7, step 806 in FIG. 8, step 905 in FIG. 9, step 1130 in FIG. 11 and step 1230 in FIG. 12. The network node 101 determines UE orientation.

The UE orientation may be determined by obtaining orientation sensor measurement information from the UE or by the network node 101 estimating the UE orientation.

### Step 1608

This step corresponds to step 603 in FIG. 6, step 704 in FIG. 7 and step 1130 in FIG. 11. The network node 101 may estimate UE location based on the received positioning measurement information.

### Step 1609

This step corresponds to step 603 in FIG. 6, step 704 in FIG. 7 and step 1130 in FIG. 11. The network node 101 may estimate the UE orientation based on the orientation sensor measurement information obtained from the UE 105.

### Step 1610

This step corresponds to step 705 in FIG. 7 and step 1140 in FIG. 11. The network node 101 may provide estimated UE orientation to the UE 105.

### Step 1611

This step corresponds to step 902 in FIG. 9. The network node 101 may provide, from the LMF 110 to the gNB-DU 101, instructions to perform measurements of reference signals.

### Step 1612

This step corresponds to step 902b in FIG. 9. The network node 101 may measure, at the gNB-DUs, reference signals, e.g. RSRP, ToA, LoS/NLoS.

### Step 1613

This step corresponds to step 903 in FIG. 9. The network node may provide, measurements from multiple network node DUs 1405 to the network node CU-CP 1401.

The measurements may comprise for example RSRP, ToA, LoS/NLoS etc.

### Step 1614

This step corresponds to step 903 in FIG. 9. The network node may obtain, at the network node CU-CP 1401, measurements from the multiple network node DUs 1405.

### Step 1615

This step corresponds to step 904 in FIG. 9. The network node may consolidate, in the network node CU-CP 1301, measurements obtained from the multiple network node DUs 1405.

### Step 1616

This step corresponds to step 905 in FIG. 9. The network node may estimate, at the network node CU-CP 1401, the UE orientation based on the consolidated measurements and using a ML algorithm.

### Step 1617

This step corresponds to step 906 in FIG. 9. The network node may provide a result of the UE positioning measurements and the estimated UE orientation from the network node CU-CP 1401 to a LMF 110.

### Step 1618

This step corresponds to step 907 in FIG. 9. The network node may determine, at the LMF 110, UE position and possibly the UE heading.

### Step 1619

This step corresponds to step 908 in FIG. 9. The network node may determine, at the LMF 110, the information of relevance.

### Step 1620

This step corresponds to step 603 in FIG. 6 and step 706 in FIG. 7. The network node 101 may determine information of relevance based on the UE location and UE orientation. The UE 105 receives the UE position, i.e. the current UE position, from the network node 101.

### Step 1621

This step corresponds to step 604 in FIG. 6, step 707 in FIG. 7, step 807 in FIG. 8, step 909 in FIG. 9, step 1150 in FIG. 11, step 1240 in FIG. 12 and step 1340 in FIG. 13. The network node 101 provides information of relevance to the UE 105.

The assistance information may be related to positioning and/or information about reference signal that UE 105 can measure for orientation estimation. Assistance information relates to the information on signals that UE 105 can perform measurements on.

Steps 1611-1618 may be performed for the uplink, and in this case it may be the gNB-DUs do the measurement of the reference signal. This is different from the downlink where it is the UE 105 that performs the measurements of the reference signal.

FIG. 16 illustrates an example with the UE orientation sensor information, and previously the term estimated UE orientation has been used. The difference between these parameters will now be briefly discussed. The estimated UE orientation is based on UE reported or network performed measurements on reference signal. In this case a UE 105 is not required to have an orientation estimation sensor. The UE 105 may be equipped with sensors that can be used to derive UE orientation information. In either of the cases, the orientation along with UE location/position information is used by the network node 101 to provide relevance information or information of relevance to the UE 105.

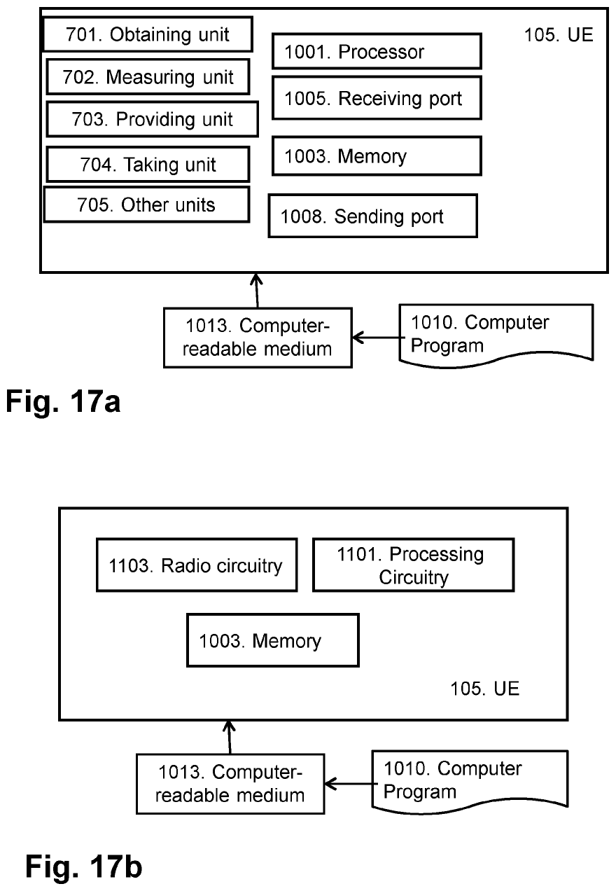

The UE 105 is adapted to perform a method described herein. To perform the method steps shown in FIGS. 6-9, 10, 12 and 15 for handling information of relevance in the communications system 100, the UE 105 may comprise an arrangement as shown in FIG. 17a and/or 17b.

The present mechanism for handling relevance information in the communications system 100 may be implemented through one or more processors, such as a processor 1001 in the arrangement depicted in FIG. 17a and/or 17b, together with computer program code for performing the functions described herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the present disclosure herein when being loaded into the UE 105. One such carrier may be in the form of a CD ROM disc. It is however feasible with other data carriers such as a memory stick. The computer program code can be provided as pure program code on a server and downloaded to the UE 105.

FIG. 17a and FIG. 17b depict two different examples in panels a) and b), respectively, of the arrangement that the UE 105 may comprise. The UE 105 may comprise the following arrangement depicted in FIG. 17a.

The present disclosure related to the UE 105 may be implemented through one or more processors, such as a processor 1001 in the UE 105 depicted in FIG. 17a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the UE 105. One such carrier may be in the form of a CD ROM disc. It is however feasible with other data carriers such as a memory stick. The computer program code may be provided as pure program code on a server and downloaded to the UE 105.

The UE 105 may comprise a memory 1003 comprising one or more memory units. The memory 1003 is arranged to be used to store obtained information, store data, configurations, schedulings, and applications etc. to perform the methods herein when being executed in the UE 105.

The UE 105 may receive information from, e.g. the network node 101, through a receiving port 1005. The receiving port 1005 may be, for example, connected to one or more antennas in UE 105. The UE 105 may receive information from another structure in the communications system 100 through the receiving port 1005. Since the receiving port 1005 may be in communication with the processor 1001, the receiving port 1005 may then send the received information to the processor 1001. The receiving port 1005 may also be configured to receive other information.

The processor 1001 in the UE 105 may be configured to transmit or send information to e.g. network node 101 or another structure in the communications system 100, through a sending port 1008, which may be in communication with the processor 1001, and the memory 1003.

The UE 105 may comprise an obtaining unit 701, measuring unit 702, providing unit 703, taking unit 704, and other unit(s) 705 etc.

Those skilled in the art will also appreciate that the obtaining unit 701, measuring unit 702, providing unit 703, taking unit 704, and other unit(s) 705 etc. described above may refer to a combination of analogue and digital circuits, and/or one or more processors configured with software and/or firmware, e.g., stored in memory, that, when executed by the one or more processors such as the processor 1001, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 701-705 described above may be implemented as one or more applications running on one or more processors such as the processor 1001.

Thus, the methods described herein for the UE 105 may be respectively implemented by means of a computer program 1010 product, comprising instructions, i.e., software code portions, which, when executed on at least one processor 1001, cause the at least one processor 1001 to carry out the actions described herein, as performed by the UE 105. The computer program 1010 product may be stored on a computer-readable storage medium 1013. The computer-readable storage medium 1013, having stored thereon the computer program 1010, may comprise instructions which, when executed on at least one processor 1001, cause the at least one processor 1001 to carry out the actions described herein, as performed by the UE 105. The computer-readable storage medium 1013 may be a non-transitory computer-readable storage medium, such as a CD ROM disc, or a memory stick. The computer program 1010 product may be stored on a carrier containing the computer program 1010 just described, wherein the carrier is one of an electronic signal, optical signal, radio signal, or the first computer-readable storage medium 1013, as described above.

The UE 105 may comprise a communication interface configured to facilitate communications between the UE 105 and other nodes or devices, e.g., the network node 101, or another structure. The interface may comprise a transceiver configured to transmit and receive radio signals over an air interface in accordance with a suitable standard.

The UE 105 may comprise the following arrangement depicted in FIG. 17b. The UE 105 may comprise a processing circuitry 1101, e.g., one or more processors such as the processor 1001, in the UE 105 and the memory 1003. The UE 105 may also comprise a radio circuitry 1103, which may comprise e.g., the receiving port 1005 and the sending port 1008. The processing circuitry 1101 may be configured to, or operable to, perform the method actions according to FIGS. 6-9, 10, 12 and 15, in a similar manner as that described in relation to FIG. 17a. The radio circuitry 1103 may be configured to set up and maintain at least a wireless connection with the UE 105. Circuitry may be understood herein as a hardware component.

Hence, the present disclosure also relates to the UE 105 operative to operate in the communications system 100. The UE 105 may comprise the processing circuitry 1101 and the memory 1003. The memory 1003 comprises instructions executable by said processing circuitry 1001. The UE 105 is operative to perform the actions described herein in relation to the UE 105, e.g., in FIGS. 6-9, 10, 12 and 15.

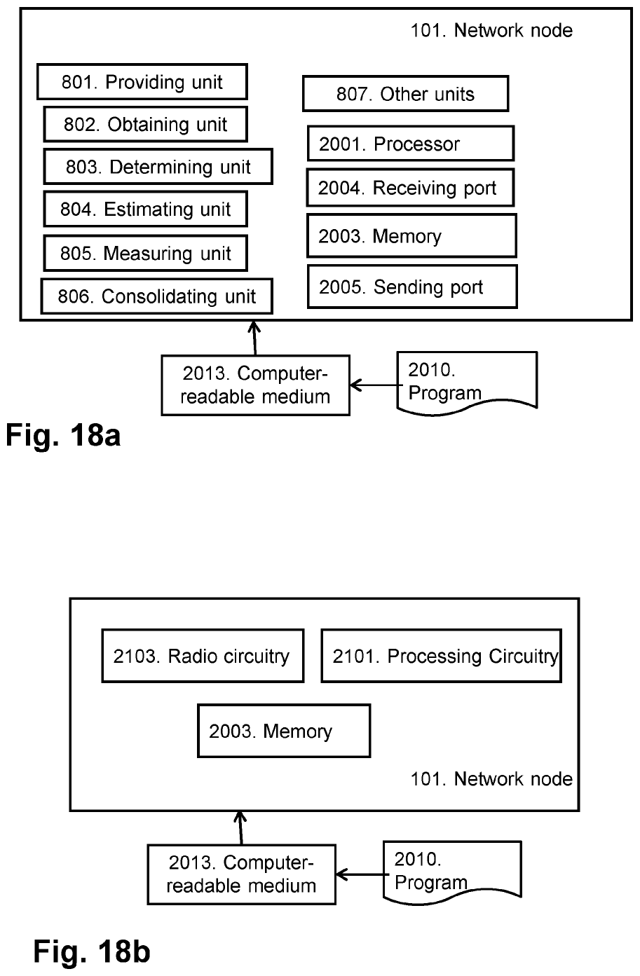

The network node 101 is adapted to perform a method described herein. To perform the method steps shown in FIGS. 6-9, 11, 13 and 16 for handling relevance information in the communications system 100, the network node 101 may comprise an arrangement as shown in FIG. 18a and/or 18b.

The present mechanism for handling relevance information in the communications system 100 may be implemented through one or more processors, such as a processor 2001 in the arrangement depicted in FIG. 18a and/or 18b, together with computer program code for performing the functions described herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the present disclosure herein when being loaded into the network node 101. One such carrier may be in the form of a CD ROM disc. It is however feasible with other data carriers such as a memory stick. The computer program code can be provided as pure program code on a server and downloaded to the network node 101.

FIG. 18a and FIG. 18b depict two different examples in panels a) and b), respectively, of the arrangement that the network node 101 may comprise. The network node 101 may comprise the following arrangement depicted in FIG. 18a.

The present disclosure associated with the network node 101 may be implemented through one or more processors, such as a processor 2001 in the network node 101 depicted in FIG. 18a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the network node 101. One such carrier may be in the form of a CD ROM disc. It is however feasible with other data carriers such as a memory stick. The computer program code may be provided as pure program code on a server and downloaded to the network node 101.

The network node 101 may comprise a memory 2003 comprising one or more memory units. The memory 2003 is arranged to be used to store obtained information, store data, configurations, schedulings, and applications etc. to perform the methods herein when being executed in the network node 101.

The network node 101 may receive information from, e.g., the UE 105, through a receiving port 2004. The receiving port 2004 may be, for example, connected to one or more antennas in network node 101. The network node 101 may receive information from another structure in the communications system 100 through the receiving port 2004. Since the receiving port 2004 may be in communication with the processor 2001, the receiving port 2004 may then send the received information to the processor 2001. The receiving port 2004 may also be configured to receive other information.

The processor 2001 in the network node 101 may be configured to transmit or send information to e.g., the UE 105, or another structure in the communications system 100, through a sending port 2005, which may be in communication with the processor 2001, and the memory 2003.

The network node 101 may comprise a providing unit 801, an obtaining unit 802, a determining unit 803, an estimating unit 804, a measuring unit 805, a consolidating unit 806 and other unit(s) 807.

Those skilled in the art will also appreciate that the providing unit 801, an obtaining unit 802, a determining unit 803, an estimating unit 804, a measuring unit 805, a consolidating unit 806 and other unit(s) 807 etc. described above may refer to a combination of analog and digital circuits, and/or one or more processors configured with software and/or firmware, e.g., stored in memory, that, when executed by the one or more processors such as the processor 2001, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

Also, the different units 801-807 described above may be implemented as one or more applications running on one or more processors such as the processor 2001.

Thus, the methods described herein for the network node 101 may be respectively implemented by means of a computer program 2010 product, comprising instructions, i.e., software code portions, which, when executed on at least one processor 2001, cause the at least one processor 2001 to carry out the actions described herein, as performed by the network node 101. The computer program 2010 product may be stored on a computer-readable storage medium 2013. The computer-readable storage medium 2013, having stored thereon the computer program 2010, may comprise instructions which, when executed on at least one processor 2001, cause the at least one processor 2001 to carry out the actions described herein, as performed by the network node 101. The computer-readable storage medium 2013 may be a non-transitory computer-readable storage medium, such as a CD ROM disc, or a memory stick. The computer program 2010 product may be stored on a carrier containing the computer program 2010 just described, wherein the carrier is one of an electronic signal, optical signal, radio signal, or the second computer-readable storage medium 2013, as described above.

The network node 101 may comprise a communication interface configured to facilitate communications between the network node 101 and other nodes or devices, e.g., the UE 105, or another structure. The interface may, for example, comprise a transceiver configured to transmit and receive radio signals over an air interface in accordance with a suitable standard.

The network node 101 may comprise the following arrangement depicted in FIG. 18b. The network node 101 may comprise a processing circuitry 2101, e.g., one or more processors such as the processor 2001, in the network node 101 and the memory 2003. The network node 101 may also comprise a radio circuitry 2103, which may comprise e.g., the receiving port 2004 and the sending port 2005. The processing circuitry 2101 may be configured to, or operable to, perform the method actions according to FIG. 6-9, 11, 13, 16 in a similar manner as that described in relation to FIG. 18a. The radio circuitry 2103 may be configured to set up and maintain at least a wireless connection with the network node 101. Circuitry may be understood herein as a hardware component.

The network node 101 may be operative to operate in the communications system 100. The network node 101 may comprise the processing circuitry 2101 and the memory 2003. The memory 2003 comprises instructions executable by the processing circuitry 2101. The network node 101 is operative to perform the actions described herein in relation to the network node 101, e.g., in FIGS. 6-9, 11, 13, 16

### Further Extensions and Variations

A telecommunication network may be connected via an intermediate network to a host computer.

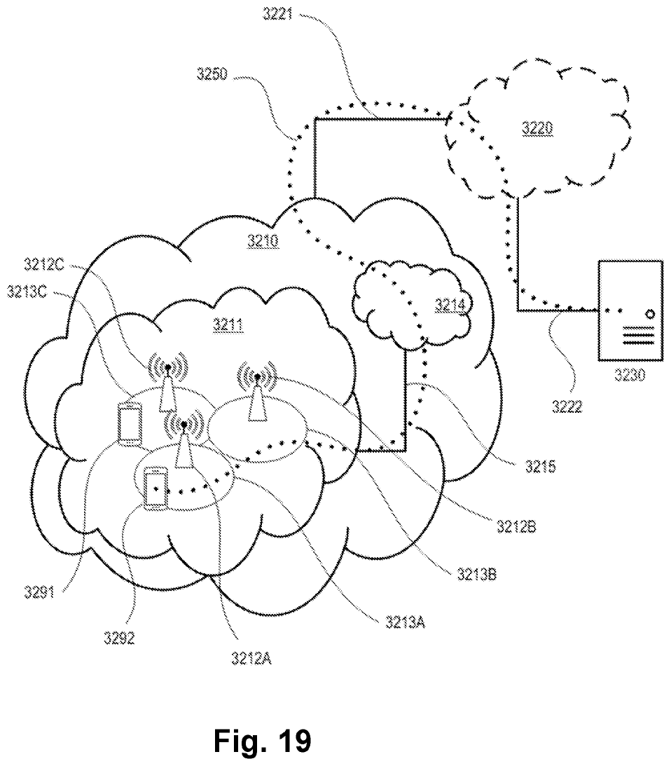

With reference to FIG. 19, a communication system comprises telecommunication network 3210 such as the communications system 100, for example, a 3GPP-type cellular network, which comprises access network 3211, such as a radio access network, and core network 3214. Access network 3211 comprises a plurality of network nodes 105. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 105 may be comprised in the communications system 100. In FIG. 19, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, it is equally applicable to a situation where a sole UE is in the coverage area or where a sole UE is connecting to the corresponding base station 3212. Any of the UEs 3291, 3292 may be considered examples of the UE 105.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 19 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

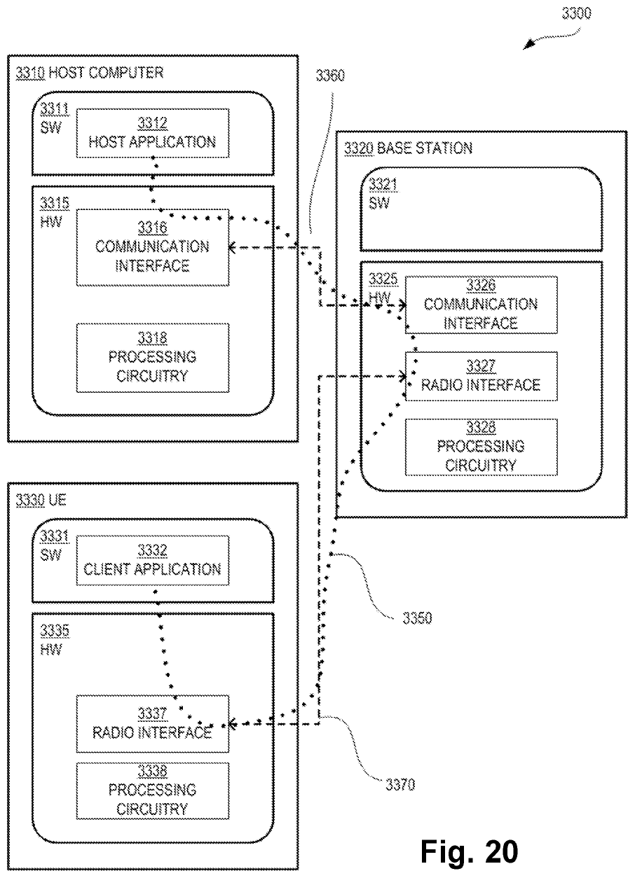

In relation to FIGS. 20-370 which are described next, it may be understood that the base station may be considered an example of the network node 101.

FIG. 20 illustrates an example of host computer communicating via a network node 101 with a UE 105 over a partially wireless connection.

The UE 105 and the network node 101, e.g., a base station and host computer discussed in the preceding paragraphs will now be described with reference to FIG. 20. In communication system 3330, such as the communications system 100, host computer 3310 comprises hardware 3315 comprising communication interface 3316 configured to set up and maintain a wired or wireless connection with an interface of a different communication device of communication system 3300. Host computer 3310 comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 comprises software 3311, which is stored in or accessible by host computer 3310 and executable by processing circuitry 3318. Software 3311 comprises host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 comprises the network node 101 exemplified in FIG. 20 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 105, exemplified in FIG. 20 as a UE 3330 located in a coverage area served by base station 3320. Communication interface 3326 may be configured to facilitate connection 3360 to host computer 3310. Connection 3360 may be direct, or it may pass through a core network (not shown in FIG. 20) of the telecommunication system and/or through one or more intermediate networks outside the telecommunication system. Hardware 3325 of base station 3320 comprises processing circuitry 3328, which may comprise one or more programmable processors, application-specific integrated circuits, field programmable gate arrays or combinations of these (not shown) adapted to execute instructions. Base station 3320 has software 3321 stored internally or accessible via an external connection.

Communication system 3300 comprises UE 3330 already referred to. It's hardware 3335 may comprise radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 20 may be similar or identical to host computer 3230, one of base stations 3212a, 3212b, 3212c and one of UEs 3291, 3292 of FIG. 19, respectively. This is to say, the inner workings of these entities may be as shown in FIG. 20 and independently, the surrounding network topology may be that of FIG. 19.

In FIG. 20, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may take decisions by which it dynamically changes the routing, e.g. based on load balancing consideration or reconfiguration of the network.

There may be a wireless connection 3370 between UE 3330 and base station 3320. The present disclosure improves the performance of OTT services provided to UE 3330 using OTT connection 3350, in which wireless connection 3370 forms the last segment. The present disclosure may improve the spectrum efficiency, and latency, and thereby provide benefits such as reduced user waiting time, better responsiveness and extended battery lifetime.

A measurement procedure may be provided for the purpose of monitoring data rate, latency and other factors on which the present disclosure improves. There may be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above or supplying values of other physical quantities from which software 3311, 3331 may compute or estimate the monitored quantities. The reconfiguring of OTT connection 3350 may comprise message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310's measurements of throughput, propagation times, latency and the like. The measurements may be implemented in that software 3311 and 3331 causes messages to be transmitted, in particular empty or dummy messages, using OTT connection 3350 while it monitors propagation times, errors etc.

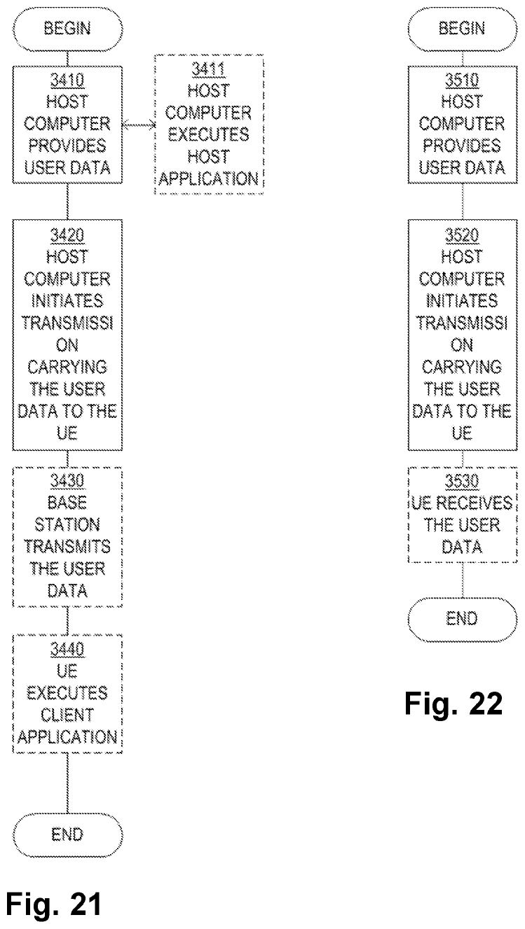

FIG. 21 illustrates an example of methods implemented in a communication system comprising a host computer, a base station and a UE 105. FIG. 21 is a flowchart illustrating a method implemented in a communication system. The communication system comprises a host computer, a base station and a UE 105 which may be those described with reference to FIG. 19 and FIG. 20. For simplicity of the present disclosure, only drawing references to FIG. 21 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits, to the UE 105, the user data which was carried in the transmission that the host computer initiated. In step 3440 (which may also be optional), the UE executes a client application associated with the host application executed by the host computer.

FIG. 22 illustrates methods implemented in a communication system comprising a host computer, a base station and a UE 105. FIG. 22 is a flowchart illustrating a method implemented in a communication system. The communication system comprises a host computer, a base station and a UE 105 which may be those described with reference to FIG. 19 and FIG. 20. For simplicity of the present disclosure, only drawing references to FIG. 22 will be comprised in this section. In step 3510 of the method, the host computer provides user data. In an optional substep (not shown) the host computer provides the user data by executing a host application. In step 3520, the host computer initiates a transmission carrying the user data to the UE 105. The transmission may pass via the base station. In step 3530 (which may be optional), the UE 105 receives the user data carried in the transmission.

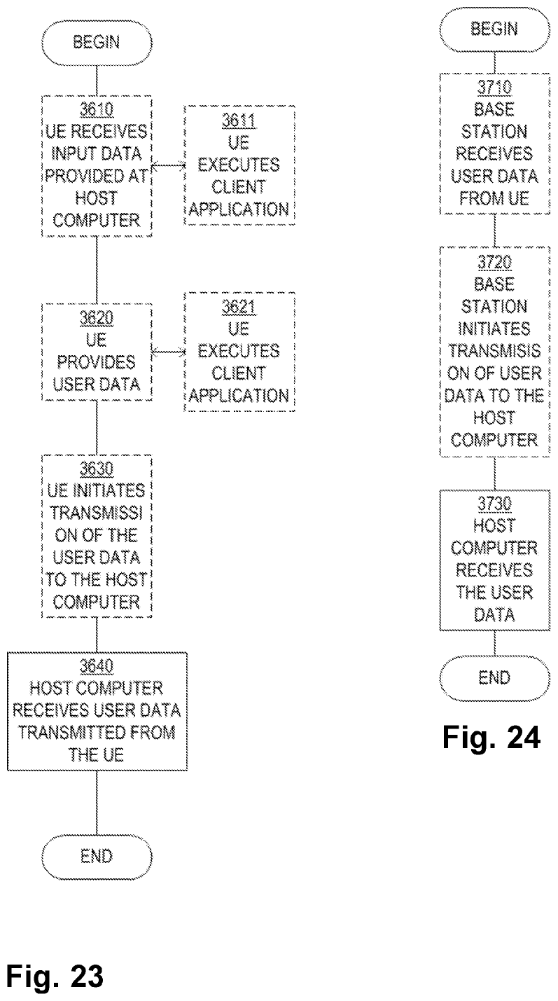

FIG. 23 illustrates methods implemented in a communication system comprising a host computer, a base station and a UE 105. FIG. 23 is a flowchart illustrating a method implemented in a communication system. The communication system comprises a host computer, a network node 101 and a UE 105 which may be those described with reference to FIG. 19 and FIG. 20. For simplicity of the present disclosure, only drawing references to FIG. 23 will be comprised in this section. In step 3610 (which may be optional), the UE 105 receives input data provided by the host computer. Additionally, or alternatively, in step 3620, the UE 105 provides user data. In substep 3621 (which may be optional) of step 3620, the UE 105 provides the user data by executing a client application. In substep 3611 (which may be optional) of step 3610, the UE 105 executes a client application which provides the user data in reaction to the received input data provided by the host computer. In providing the user data, the executed client application may consider user input received from the user. Regardless of the specific way the user data was provided, the UE 105 initiates, in substep 3630 (which may be optional), transmission of the user data to the host computer. In step 3640 of the method, the host computer receives the user data transmitted from the UE 105.

FIG. 24 illustrates methods implemented in a communication system comprising a host computer, a base station and a UE 105. FIG. 24 is a flowchart illustrating a method implemented in a communication system. The communication system comprises a host computer, a base station and a UE 105 which may be those described with reference to FIG. 19 and FIG. 20. For simplicity of the present disclosure, only drawing references to FIG. 24 will be comprised in this section. In step 3710 (which may be optional), the base station receives user data from the UE 105. In step 3720 (which may be optional), the base station initiates transmission of the received user data to the host computer. In step 3730 (which may be optional), the host computer receives the user data carried in the transmission initiated by the base station.

The present disclosure may be summarized as follows:

A base station is configured to communicate with a UE 105. The base station comprises a radio interface and processing circuitry configured to perform one or more of the actions described herein as performed by the network node 101.

A communication system 100 comprises a host computer, and the communication system 100 comprises:
processing circuitry configured to provide user data; and
a communication interface configured to forward the user data to a cellular network for transmission to a UE 105,
wherein the cellular network comprises a network node 101 having a radio interface and processing circuitry, the base station's processing circuitry configured to perform one or more of the actions described herein as performed by the network node 101.

The communication system 100 may comprise the network node 101.

The communication system 100 may comprise the UE 105. The UE 105 is configured to communicate with the network node 101.

The communication system 101, wherein:
the processing circuitry of the host computer is configured to execute a host application, thereby providing the user data; and
the UE 105 comprises processing circuitry configured to execute a client application associated with the host application.

A method implemented in a network node 101. The method comprises one or more of the actions described herein as performed by the network node 101.

A method implemented in a communication system 100 comprising a host computer, a base station and a UE 105, the method comprising:
at the host computer, providing user data; and
at the host computer, initiating a transmission carrying the user data to the UE 105 via a cellular network comprising the network node 101, wherein the network node 101 performs one or more of the actions described herein as performed by the network node 101.

The method may comprise:
at the network node 101, transmitting the user data.

The user data may be provided at the host computer by executing a host application, and the method may comprise:
at the UE 105, executing a client application associated with the host application.

A UE 105 configured to communicate with a network node 101. The UE 105 comprises a radio interface and processing circuitry configured to perform one or more of the actions described herein as performed by the UE 105.

A communication system 100 comprises a host computer. The communication system 100 comprises:
processing circuitry configured to provide user data; and
a communication interface configured to forward user data to a cellular network for transmission to a UE 105,
wherein the UE 105 comprises a radio interface and processing circuitry, the UE's processing circuitry configured to perform one or more of the actions described herein as performed by the UE 105.

The communication system 100 may comprise the UE 105.

The communication system 100, wherein the cellular network comprises a network node 101 configured to communicate with the UE 105.

The communication system 100, wherein:
the processing circuitry of the host computer is configured to execute a host application, thereby providing the user data; and
the UE's processing circuitry is configured to execute a client application associated with the host application.

A method implemented in a UE 105, comprising one or more of the actions described herein as performed by the UE 105.

A method implemented in a communication system 100 comprising a host computer, a network node 101 and a UE 105, the method comprising:
at the host computer, providing user data; and
at the host computer, initiating a transmission carrying the user data to the UE 105 via a cellular network comprising the base station, wherein the UE 105 performs one or more of the actions described herein as performed by the UE 105.

The method may comprise:
at the UE 105, receiving the user data from the network node 101.

A UE 105 configured to communicate with a network node 101, the UE 105 comprising a radio interface and processing circuitry configured to perform one or more of the actions described herein as performed by the UE 105.

A communication system 100 comprising a host computer comprising:
a communication interface configured to receive user data originating from a transmission from a UE 105 to a network node 101,
wherein the UE 105 comprises a radio interface and processing circuitry, the UE's processing circuitry configured to: perform one or more of the actions described herein as performed by the UE 105.

The communication system 100 may comprise the UE 105.

The communication system 100 may comprise the network node 101, wherein the network node 101 comprises a radio interface configured to communicate with the UE 105 and a communication interface configured to forward to the host computer the user data carried by a transmission from the UE 105 to the base station.

The communication system 100, wherein:
the processing circuitry of the host computer is configured to execute a host application; and
the UE's processing circuitry is configured to execute a client application associated with the host application, thereby providing the user data.

The communication system 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 105, comprising one or more of the actions described herein as performed by the UE 105.

The method may comprise:
providing user data; and
forwarding the user data to a host computer via the transmission to the network node 101.

A method implemented in a communication system 100 comprising a host computer, a network node 101 and a UE 105, the method comprising:
at the host computer, receiving user data transmitted to the network node 101 from the UE 105, wherein the UE 105 performs one or more of the actions described herein as performed by the UE 105.

The method may comprise:
at the UE 105, providing the user data to the network node 101.

The method may comprise:
at the UE 105, executing a client application, thereby providing the user data to be transmitted; and
at the host computer, executing a host application associated with the client application.

The method may comprise:
at the UE 105, executing a client application; and
at the UE 105, receiving input data to the client application, the input data being provided at the host computer by executing a host application associated with the client application,
wherein the user data to be transmitted is provided by the client application in response to the input data.

A network node 101 configured to communicate with a UE 105, the network node 101 comprising a radio interface and processing circuitry configured to perform one or more of the actions described herein as performed by the network node 101.

A communication system 100 comprising a host computer comprising a communication interface configured to receive user data originating from a transmission from a UE 105 to a base station, wherein the network node 101 comprises a radio interface and processing circuitry, the base station's processing circuitry configured to perform one or more of the actions described herein as performed by the network node 101.

The communication system 100 may comprise the network node 101.

The communication system 100 may comprise the UE 105, wherein the UE 105 is configured to communicate with the network node 101.

The communication system 100 wherein:
the processing circuitry of the host computer is configured to execute a host application;
the UE 105 is configured to execute a client application associated with the host application, thereby providing the user data to be received by the host computer.

A method implemented in a network node 101, comprising one or more of the actions described herein as performed by any of the network node 101.

A method implemented in a communication system comprising a host computer, a network node 101 and a UE 105, the method comprising:
at the host computer, receiving, from the network node 101, user data originating from a transmission which the base station has received from the UE 105, wherein the UE 105 performs one or more of the actions described herein as performed by the UE 105.

The method may comprise:
at the network node 101, receiving the user data from the UE 105.

The method may comprise:
at the network node 101, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

ABBREVIATIONS

| Abbreviation | Explanation |
|---|---|
| 3GPP | 3^{rd} Generation Partnership Project |
| AMF | Access and Mobility Management Function |
| CRS | Cell specific reference signal |
| CSI-RS | Channel State Information Reference Signal |
| DL PRS | Downlink Positioning Reference Signal |
| DL-AoD | Downlink Angle of Departure |
| DL-TDoA | Downlink Time Difference of Arrival |
| DMRS | Demodulation Reference Signal |
| gNB | gNodeB |
| gNB Rx-Tx | gNB Rx Tx time difference |
| gNB-CU-CP | gNB Central Unit Control Plane |
| gNB-CU-UP | gNB Central Unit User Plane |
| KNN | K-nearest Neighbor |
| LMF | Location and Mobility Function |
| LPP | LTE Positioning Protocol |
| LTE | Long Term Evolution |
| ML | Machine Learning |
| NR | New Radio |
| NRPPa | NR Positioning Protocol annex |
| PRS | Positioning Reference Signal |
| PSS | Primary Synchronization Signal |
| RRC | Radio Resource Control |
| RSRP | Reference Signal Received Power |
| RSTD | Reference Signal Time Difference |
| RTT | Round Trip Time |
| SSB | Synchronization Signal Block |
| SSS | Secondary Synchronization Signal |
| TA | Timing Advance |
| TRP | Transmission and Reception Point |
| UE | User Equipment |
| UE Rx-Tx | UE Rx-Tx Time Difference Measurement |
| UL-AoA | Uplink Angle of Arrival |
| UL-RToA | Uplink Relative Time of Arrival. |
| UL-TDoA | Uplink Time Difference of Arrival. |

1-25. (canceled)

26. A method performed by a User Equipment (UE) for handling information of relevance during a positioning occasion in a communications system, the method comprising:
obtaining assistance information from a network node, wherein the assistance information is related to reference signals measurable by the UE;
measuring reference signals based on the assistance information, wherein the reference signals are measured from reference Transmission and Reception Points (TRPs) and target TRPs;
providing positioning measurement information based on the measured reference signals to the network node;
obtaining UE orientation information from the network node, wherein the UE orientation information has been estimated by the network node;
obtaining information of relevance from the network node, wherein the information of relevance is dependent on a UE position in which the UE is currently located and a UE orientation; and
taking an action based on the obtained information of relevance.

27. The method according to claim 26, wherein the information of relevance comprises one or more of the following:
navigation instruction based on which UE may change its position to a new position and gets remotely navigated to the new position;
augmented data based on the UE orientation and its location; or
the estimated UE location in which the UE is currently located and UE orientation and that UE further exploits to take further actions.

28. The method according to claim 26, wherein at least one of the following applies:
the reference signals are measured for positioning purposes;
the reference signals are measured for orientation estimation; or
wherein the measuring comprises a Line of Sight (LoS) and/or a Non Line of Sight (NLoS) condition of the UE with all TRPs in a deployment of TRPs.

29. The method according to claim 26, further comprising obtaining, from the network node, a request to report positioning measurement information.

30. The method according to claim 26, further comprising obtaining, from the network node, a request to provide information indicating Line of Sight (LoS) or a Non line of Sight (NloS) conditions of the UE with respect to a deployment of TRPs.

31. The method according to claim 26, further comprising:
obtaining, from one or more orientation sensors associated with the UE, orientation sensor measurement information indicating orientation of the UE; and
providing, to the network node, orientation sensor measurement information.

32. The method according to claim 26, further comprising obtaining, from the network node, a request for UE positioning capability information.

33. The method according to claim 26, further comprising providing UE positioning capability information to the network node, wherein the UE positioning capability information indicates that the UE is capable of performing position related measurements.

34. The method according to claim 26, further comprising providing, to the network node, information indicating an availability of a sensor for orientation measurement.

35. A method performed by a network node for handling information of relevance during a positioning occasion in a communications system, the method comprising:
providing assistance information to a User Equipment (UE) wherein the assistance information is related to at least one of: positioning and information about a reference signal measurable by the UE;
obtaining positioning measurement information from the UE, wherein the positioning measurement information is based on reference signals from reference Transmission and Reception Points (TRPs) and target TRPs;
determining UE orientation based on the positioning measurement information; and
providing information of relevance to the UE, wherein the information of relevance is dependent on UE position in which the UE is currently located and the UE orientation.

36. The method according to claim 35, wherein the UE orientation is determined by obtaining orientation sensor measurement information from the UE or by the network node estimating the UE orientation.

37. The method according to claim 35, further comprising providing, to the UE, a request for UE positioning capability information.

38. The method according to claim 35, further comprising obtaining UE positioning capability information from the UE, wherein the UE positioning capability information indicates that the UE is capable of performing position related measurements.

39. The method according to claim 35, further comprising providing, to the UE, a request to report positioning measurement information.

40. The method according to claim 35, further comprising providing, to the UE, a request to provide information indicating Line of Sight (LoS or Non line of Sight, (NloS) conditions of the UE with respect to a deployment of TRPs.

41. The method according to claim 35, further comprising obtaining, from the UE, UE orientation sensor measurement information.

42. The method according to claim 41, further comprising:
estimating UE location where the UE is currently located and based on the obtained positioning measurement information;
estimating the UE orientation based on the UE orientation sensor measurement information obtained from the UE;
providing estimated UE orientation to the UE; and
determining information of relevance based on the estimated UE location and estimated UE orientation.

43. A User Equipment (UE) for handling information of relevance during a positioning occasion in a communications system, wherein the UE comprises:
radio circuitry; and
processing circuitry configured to use the radio circuitry to:
obtain assistance information from a network node, wherein the assistance information is related to reference signals measurable by the UE;
measure reference signals based on the assistance information, wherein the reference signals are measured from reference Transmission and Reception Points (TRPs) and target TRPs;
provide positioning measurement information based on the measured reference signals to the network node;
obtain UE orientation information from the network node, wherein the UE orientation information has been estimated by the network node;
obtain information of relevance from the network node, wherein the information of relevance is dependent on a UE position in which the UE is currently located and a UE orientation; and
wherein the processing circuitry is further configured take an action based on the obtained information of relevance.

44. A network node for handling information of relevance during a positioning occasion in a communications system, wherein the network node comprises:
radio circuitry; and
processing circuitry configured to use the radio circuitry to:
provide assistance information to a User Equipment (UE), wherein the assistance information is related to positioning or information about a reference signal measurable by the UE; and
obtain positioning measurement information from the UE, wherein the positioning measurement information is based on reference signals from reference Transmission and Reception Points (TRPs) and target TRPs; and
wherein the processing circuitry is further configured to:
determine UE orientation based on the positioning measurement information; and
provide information of relevance to the UE, wherein the information of relevance is dependent on UE position in which the UE is currently located and the UE orientation.
